(19) United States
(12) Patent Application Publication
(10) Pub. No.: US 2012/0116635 A1
(43) Pub. Date: May 10, 2012

(54) CONTROL TARGET PROCESSING SYSTEM

(75) Inventors: Yoshihiro Ohkuwa, Numadu-shi (JP); Yukio Otake, Mishima-shi (JP)

(73) Assignee: TOYOTA JIDOSHA KABUSHIKI KAISHA, Toyota-shi (JP)

(21) Appl. No.: 13/383,558

(22) PCT Filed: Jul. 9, 2010
(86) PCT No.: PCT/IB2010/001689

§ 371 Date: Jan. 11, 2012

(30) Foreign Application Priority Data
Jul. 13, 2009 (JP) 2009-164640

(51) Int. Cl. G06G 7/70; B62D 6/00; G06F 7/00

(52) U.S. Cl. 701/41; 701/36; 701/70; 701/101

(57) ABSTRACT

A control target processing system includes: a first generating unit that generates first time-series data that are time-series data of an input value; a second generating unit that is formed of a plurality of processing units, that exchanges time-series data among the plurality of processing units, and that calculates intermediate computation values corresponding to the respective input values contained in the input time-series data in the respective processing units to thereby generate second time-series data that are time-series data of the intermediate computation value; a selecting unit that selects a selection value from among the second time-series data in accordance with a first selection condition; and an output unit that calculates and outputs a control variable for controlling a controlled object on the basis of the selection value.

### BACKGROUND OF THE INVENTION

1. Field of the Invention

The invention relates to a control target processing system.

2. Description of the Related Art

In an existing art, there is known a road information detecting system that sets a vehicle as a controlled object and that outputs a vehicle control variable based on a measured distance between the vehicle and a stationary object (for example, a roadside reflector) that serves as a mark on a road (for example, see Japanese Patent Application Publication No. 2007-290505 (JP-A-2007-290505)). In the road information detecting system described in JP-A-2007-290505, the measured distance is corrected in consideration of a vehicle movement during a period of time from measurement of the distance to a start of vehicle control, and then the corrected measured distance is incorporated in the vehicle control variable to thereby improve the reliability of vehicle control.

However, if a computation of the control variable delays in the above described road information detecting system, a vehicle movement during a delay period is not incorporated in the vehicle control variable. Thus, in this road information detecting system, an inappropriate vehicle control variable that does not match an actual situation may possibly be output because of a delay of processing, so the reliability of vehicle control may not be sufficiently improved.

### SUMMARY OF THE INVENTION

The invention provides a control target processing system that is able to improve the reliability of control over a controlled object.

A first aspect of the invention provides a control target processing system. The control target processing system includes: a first generating unit that generates first time-series data that are time-series data of an input value; a second generating unit that is formed of a plurality of processing units, that exchanges the time-series data among the plurality of processing units, and that calculates intermediate computation values corresponding to the respective input values contained in the first time-series data through predetermined processes in the respective processing units to thereby generate second time-series data that are time-series data of the intermediate computation value; a selecting unit that selects a selection value from among the second time-series data in accordance with a first selection condition; and an output unit that calculates a control variable for controlling a controlled object on the basis of the selection value and then outputs the control variable as a control target.

With the control target processing system according to the first aspect of the invention, time-series data are exchanged among the plurality of processing units, and a selection value used for calculating a control variable is selected from among the finally generated second time-series data in accordance with a first selection condition. Thus, with the control target processing system, even when a delay occurs in a plurality of processes, a selection value suitable for calculating a control variable that is a control target may be flexibly selected for an actual period of time consumed for the processes, so it is possible to improve the reliability of control over a controlled object.

In the first aspect of the invention, the first generating unit may estimate a future input value and may generate the first time-series data containing the future input value. In this case, by generating the second time-series data containing a future intermediate computation value corresponding to the future input value, a selectable range for a selection value widens, so it is possible to select a further suitable selection value for calculating a control variable.

In addition, in the first aspect of the invention, the first generating unit may generate a plurality of types of first value time-series data corresponding to a plurality of types of input values, the second generating unit may generate a plurality of types of second time-series data on the basis of the plurality of types of first value time-series data, the selecting unit may select selectable data ranges from among the respective types of second time-series data in accordance with a second selection condition, and the output unit may calculate the control variables from intermediate computation values contained in the respective selectable data ranges.

With the above configuration, when control variables calculated from a plurality of types of input values are output as control targets, selectable data ranges used for calculating the control variables are respectively selected from among a plurality of types of second time-series data in accordance with a second selection condition. Thus, with the control target processing system, even when a delay occurs in a plurality of processes, selectable data ranges suitable for calculating control variables may be flexibly selected for an actual period of time consumed for the processes, so it is possible to improve the reliability of control over a controlled object.

In addition, in the first aspect of the invention, the first generating unit may generate the first time-series data having a time length set on the basis of a processing period of time. In this case, the time length of first time-series data is set on the basis of a processing delay time that irregularly fluctuates, so the data length may be reduced while ensuring the data length necessary for control process. By so doing, it is possible to reduce the processing load and increase the processing speed.

In addition, in the first aspect of the invention, the control target processing system may further include a calculation unit that calculates a control timing at which the controlled object is controlled in accordance with the control variable, wherein the output unit may output the control target on the basis of the control timing. The above control timing corresponds to a driving timing at which a controller (actuator) that drives a controlled object operates or an operation timing at which a calculated control variable is applied to the controlled object through the controller, and a selection value is selected so that a control variable that is appropriately applied at the control timing is calculated to thereby make it possible to output a control target having a further high control accuracy.

### BRIEF DESCRIPTION OF THE DRAWINGS

The features, advantages, and technical and industrial significance of this invention will be described in the following detailed description of example embodiments of the invention with reference to the accompanying drawings, in which like numerals denote like elements, and wherein:

FIG. 1 is a configuration diagram that shows a control target processing system according to a first embodiment;

FIG. 2 is a view that shows the flow of processes in the control target processing system according to the first embodiment;

FIG. 3 is a view that shows intermediate computation value time-series data;

FIG. 4 is a flowchart that shows the operation of an input ECU shown in FIG. 1;

FIG. 5 is a flowchart that shows the operation of a processing ECU shown in FIG. 1;

FIG. 6 is a flowchart that shows the operation of a control ECU shown in FIG. 1;

FIG. 7 is a view that shows the temporal relationship between intermediate computation value time-series data and a control timing;

FIG. 8 is a view that shows intermediate computation value time-series data containing a future computation value;

FIG. 9 is a view that shows a set of pieces of intermediate computation value time-series data;

FIG. 10 is a configuration diagram that shows a control target processing system according to a second embodiment;

FIG. 11 is a view that shows the flow of processes in the control target processing system shown in FIG. 10;

FIG. 12 is a view that shows a plurality of types of intermediate computation value time-series data;

FIG. 13 is a flowchart that shows the operation of an input ECU shown, in FIG. 10;

FIG. 14 is a flowchart that shows the operation of a processing ECU shown in FIG. 10;

FIG. 15 is a flowchart that shows the operation of a control ECU shown in FIG. 10;

FIG. 16 is a view that shows an example of selected selectable data ranges;

FIG. 17 is a view that shows a set of pieces of intermediate computation value time-series data;

FIG. 18 is a view that shows the flow of processes in a control target processing system according to a third embodiment;

FIG. 19 is a graph that shows a time consumed for process, or the like, in the control target processing system according to the third embodiment;

FIG. 20 is a view that shows the flow of processes in a control target processing system according to a fourth embodiment;

FIG. 21 is a view that shows another example of the flow of processes in the control target processing system according to the fourth embodiment;

FIGS. 22A and 22B are configuration diagrams that shows a control target processing system according to a fifth embodiment;

FIG. 23 is a flowchart that shows the operation of an image ECU shown in FIG. 22A;

FIG. 24 is a flowchart that shows the operation of a radar ECU shown in FIG. 22A;

FIG. 25 is a flowchart that shows the operation of a location calculation ECU shown in FIG. 22A;

FIG. 26 is a flowchart that shows the operation of a recognition ECU shown in FIG. 22A;

FIG. 27 is a flowchart that shows the operation of a driving target ECU shown in FIG. 22B;

FIG. 28 is a flowchart that shows the operation of a driving control ECU shown in FIG. 22B;

FIG. 29 is a plan view that shows the result of driving control over a vehicle that includes no control target processing system;

FIG. 30 is a plan view that shows the result of driving control over a vehicle that includes the control target processing system shown in FIGS. 22A and 22B;

FIG. 31 is a configuration diagram that shows a control target processing system according to a sixth embodiment;

FIG. 32 is a view for illustrating conversion of input values in a data management ECU shown in FIG. 31;

FIG. 33 is a flowchart that shows the operation of an input ECU shown in FIG. 31;

FIG. 34 is a flowchart that shows the data saving operation of the data management ECU shown in FIG. 31;

FIG. 35 is a flowchart that shows the data output operation of the data management ECU shown in FIG. 31;

FIG. 36 is a flowchart that shows the operation of a control ECU shown in FIG. 31;

FIG. 37 is a flowchart that shows the operation of an actuator control ECU shown in FIG. 31;

FIG. 38 is a configuration diagram that shows a control target processing system according to a seventh embodiment;

FIG. 39 is a view for illustrating calculation of a control timing in a control ECU shown in FIG. 38;

FIG. 40 is a flowchart that shows the operation of a recognition ECU shown in FIG. 38; and

FIG. 41 is a flowchart that shows the operation of a control ECU shown in FIG. 38.

### DETAILED DESCRIPTION OF EMBODIMENTS

Hereinafter, embodiments of a control target processing system according to the invention will be described in detail with reference to the accompanying drawings. Note that, in the illustration of the drawings, like reference numerals denote similar components and the overlap description is omitted.

### First Embodiment

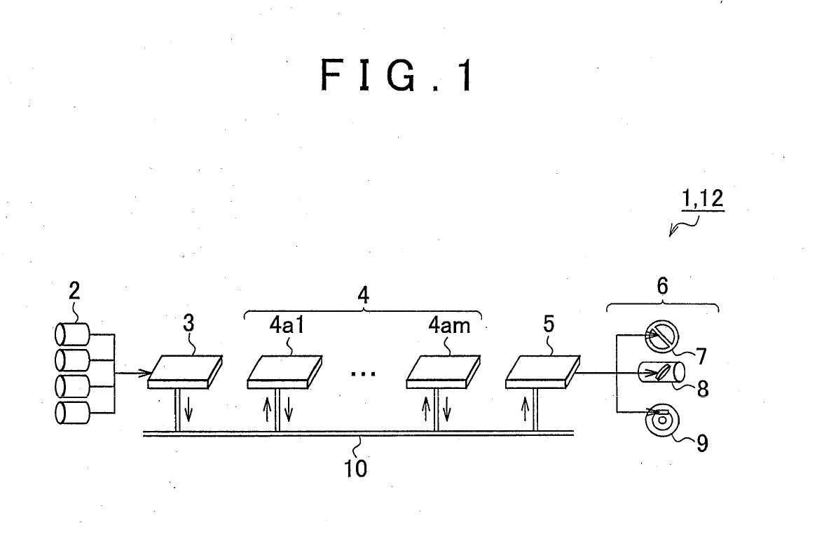

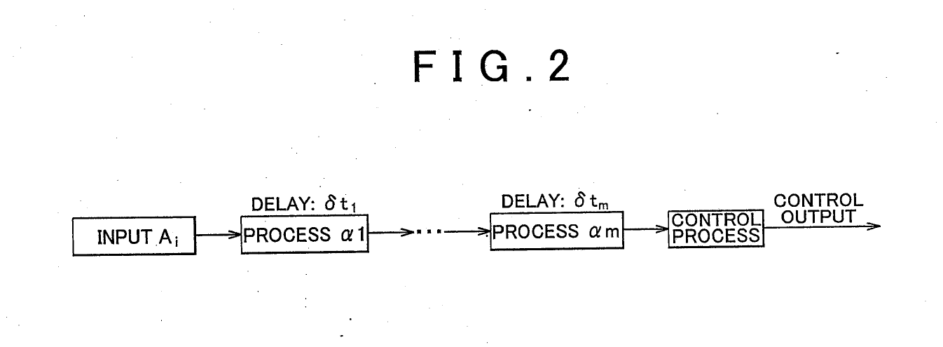

First, a control target processing system 1 according to a first embodiment will be described with reference to the accompanying drawings. As shown in FIG. 1 and FIG. 2, the control target processing system 1 according to the present embodiment is provided for a vehicle (controlled object), and outputs control variables based on an input value from a sensor 2, such as a vehicle speed sensor, as a control target to actuators 6 for controlling the vehicle. The control target processing system 1 includes the sensor 2, an input electronic control unit (ECU) 3, a processing ECU 4 and a control ECU 5. Note that the input ECU 3 functions as a first generating unit, the processing ECU 4 functions as a second generating unit and the control ECU 5 functions as a selecting unit and an output unit.

Each of the input ECU 3, the processing ECU 4 and the control ECU 5 is an electronic control unit formed of a central processing unit (CPU) that executes processes, a read only memory (ROM) that serves as a storage unit, a random access memory (RAM), an input signal circuit, an output signal circuit, a power supply circuit, and the like. The input ECU 3, the processing ECU 4 and the control ECU 5 are electrically connected to one another via a vehicle local area network (LAN) 10. In addition, the input ECU 3, the processing ECU 4 and the control ECU 5 share a system timer for acquiring time information.

The sensor 2 is provided for the vehicle, and detects necessary information (vehicle speed, vehicle location) for controlling the actuators 6 for controlling the vehicle. The sensor 2 outputs the detected information to the input ECU 3.

The input ECU 3 is electrically connected to the sensor 2, and acquires the detected information input from the sensor 2 as an input value. In addition, the input ECU 3 acquires an input time of the input value on the basis of time information acquired from the system timer. The input ECU 3 saves the input value and the input time. The input ECU 3 generates input time-series data N that are time-series data of the input value. IN the input time-series data N, the input value is associated with the input time. The input ECU 3 outputs the generated input time-series data N to the processing ECU 4.

The processing ECU 4 acquires the input time-series data N input from the input ECU 3. The processing ECU 4 generates intermediate computation value time-series data J, which are time-series data of the intermediate computation value, on the basis of the acquired input time-series data N. The intermediate computation value is computed by the time when the control variable is calculated from the input value. The processing ECU 4 is formed of a plurality of ECUs 4a1 to 4am (m is natural number larger than or equal to 2). The plurality of ECUs 4a1 to 4am function as processing units. In the processing ECU 4, processes α1 to αm (m is natural number larger than or equal to 2) in the respective ECUs 4a1 to 4am are sequentially executed on the input time-series data N to thereby generate the intermediate computation value time-series data J. At this time, data are exchanged in the format of time-series data among the ECUs 4a1 to 4am. The processing ECU 4 outputs the generated intermediate computation value time-series data J to the control ECU 5.

The control ECU 5 acquires the intermediate computation value time-series data J input from the processing ECU 4. The control ECU 5 selects a value optimal for generating a control target as a selection value K from among the intermediate computation value time-series data J. The control ECU 5 calculates a control variable output as the control target on the basis of the selection value K. Note that the selection value K may contain a plurality of intermediate computation values.

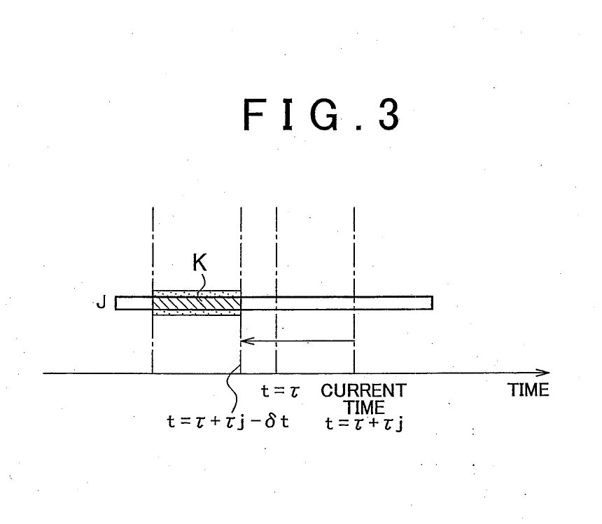

At this time, the control ECU 5 selects the selection value K in accordance with a preset first selection condition. The above first selection condition may be various. For example, an appropriate condition is selected as the first selection condition in accordance with a purpose, such as reduction in temporal variations of the input value, compatibility with sensor characteristic and removal of adverse effect of a processing delay time. An example of the first selection condition is a condition for selecting a data range based on a current time with respect to the current time. In this case, as shown in FIG. 3, with reference to a time τ at which the control ECU 5 has acquired the intermediate computation value time-series data J, an intermediate computation value corresponding to a time τ+τj−δT that is obtained by subtracting a predetermined value δT from the current time τ+τj is selected as the selection value K from among the intermediate computation value time-series data J. The control ECU 5 calculates control variables on the basis of the selection value K, and outputs the calculated control variables as control targets to the actuators 6.

The actuators 6 are actuators for controlling the vehicle, and include a steering actuator 7 that drives the steering of the vehicle, a throttle actuator 8 that drives the throttle of an engine, a brake actuator 9 that drives a brake system, and the like. The driving of the actuators 6 is controlled in accordance with the control variable output from the control ECU 5. By so doing, driving control over the vehicle is executed.

Next, the operation of the ECUs of the thus configured control target processing system 1 will be described with reference to the accompanying drawings.

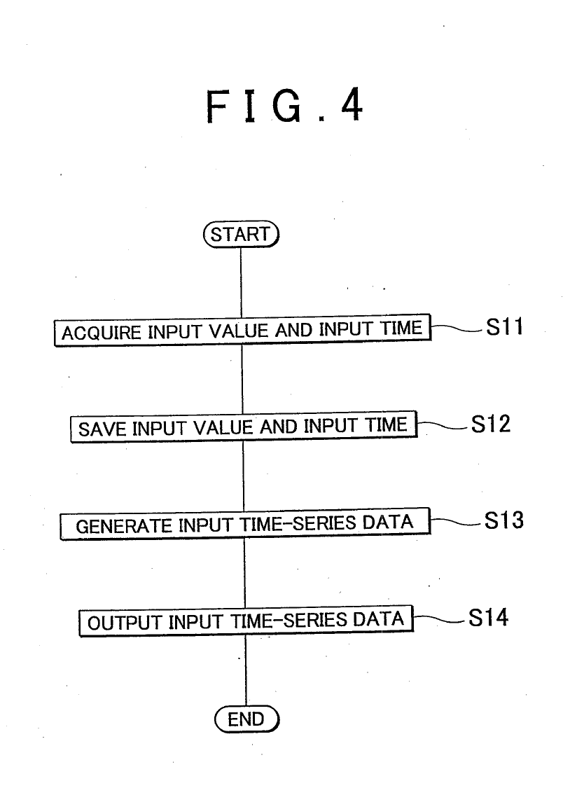

As shown in FIG. 4, the input ECU 3 acquires the detected information of the sensor 2 as an input value, and acquires an input time of the input value on the basis of time information acquired from the system timer (S11). Subsequently, the input ECU 3 saves the input value and the input time (S12). After that, the input ECU 3 generates input time-series data N, which are time-series data of the input value (S13). The input ECU 3 outputs the generated input time-series data N to the processing ECU 4 (S14). After that, the process ends.

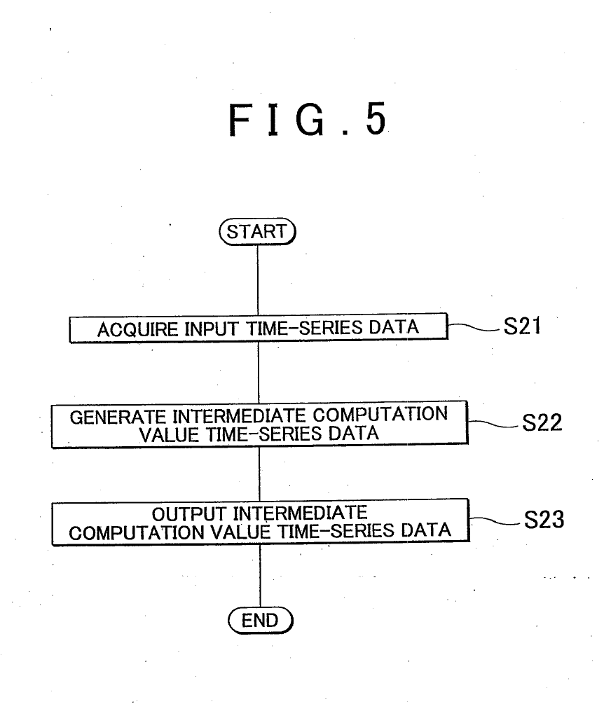

As shown in FIG. 5, the processing ECU 4 acquires the input time-series data N output from the input ECU 3 (S21). After that, the processing ECU 4 generates intermediate computation value time-series data J on the basis of the input time-series data N (S22). At this time, as shown in FIG. 2, in the ECUs 4a1 to 4am that constitute the processing ECU 4, irregular processing delay times δt₁ to δtₘ occur in communication processings among the ECUs or in processes α1 to αm. The processing ECU 4 outputs the generated intermediate computation value time-series data J to the control ECU 5 (S23). After that, the process ends.

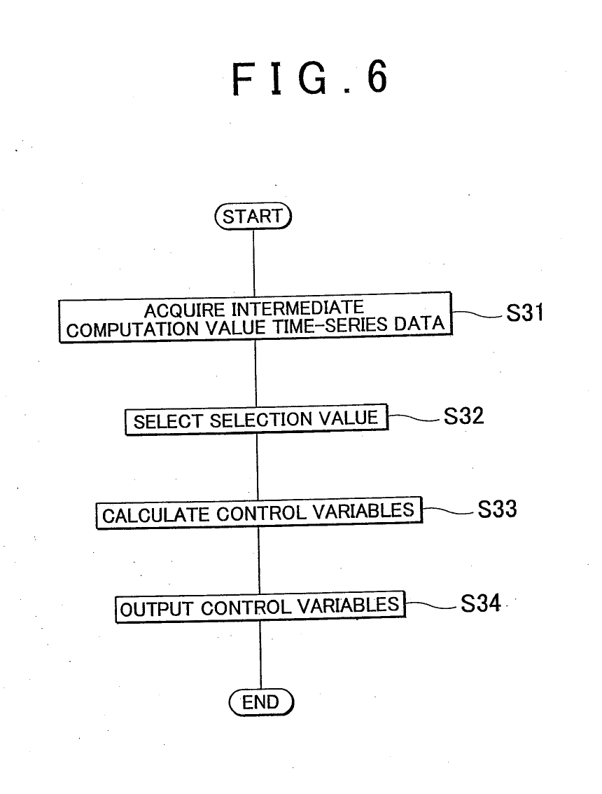

As shown in FIG. 6, the control ECU 5 acquires the intermediate computation value time-series data J input from the processing ECU 4 (S31). The control ECU 5 selects a selection value K from among the intermediate computation value time-series data J in accordance with the first selection condition (S32). The control ECU 5 calculates control variables on the basis of the selected selection value K (S33). The control ECU 5 outputs the calculated control variable as a control target to the actuators 6 (S34). After that, the process ends.

With the above described control target processing system 1, time-series data are exchanged among the ECUs 4a1 to 4am that constitute the processing ECU 4, and the selection value K used for calculating the control variable is selected from among the finally generated intermediate computation value time-series data J in accordance with the first selection condition. Thus, with the control target processing system 1, even when irregular processing delay times δt₁ to δtₘ occur in a plurality of processes, a selection value K appropriate for calculating the control variable may be flexibly selected in accordance with an actual time consumed for processes, so it is possible to improve the reliability of control over the controlled object.

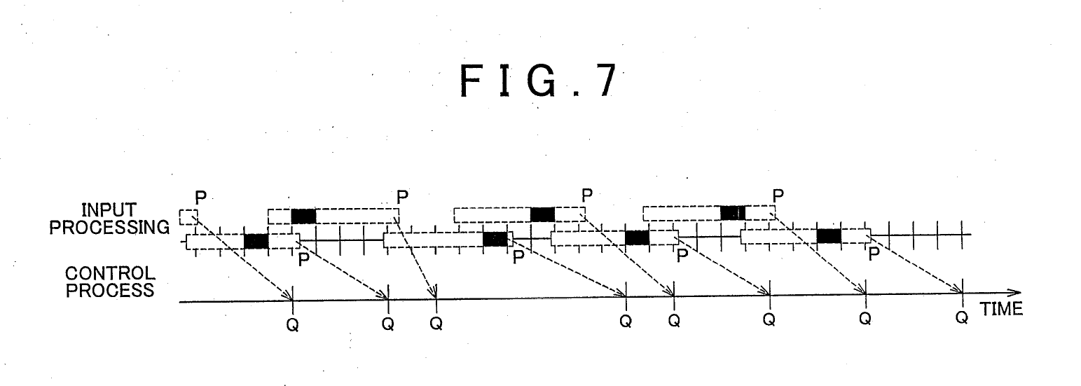

Specifically, in the control target processing system 1, as shown in FIG. 3 and FIG. 7, a selection value K corresponding to a time going back a certain period of time from a current time is selected from among the intermediate computation value time-series data J in accordance with the first selection condition. By so doing, irrespective of the influence of a processing delay time (for example, temporal variations in end time P of the intermediate computation value time-series data J shown in FIG. 7), it is possible to output control variables at a regular timing with respect to a control timing Q at which the actuators 6 are driven, so it is possible to improve the reliability of driving control over the vehicle.

Note that the first selection condition is not limited to the above described conditions. For example, a condition for selecting a combination suitable for the mathematical expressions used in processes may be employed as the first selection condition. Specifically, when it is assumed that a target trajectory for driving control over the vehicle is output as control target, time-series data (corresponding to intermediate computation value time-series data J) of the target trajectory P are expressed by the following mathematical expression (1), and P(τ) that is one element of the intermediate computation value is expressed by the following mathematical expression (2). Here, τ in the mathematical expression (1) is a variable that indicates a time, and a and b are arbitrary natural numbers. In addition, x in the mathematical expression (2) is an x-coordinate value when a plane in which the vehicle drives is represented as x-y coordinates, and y is a y-coordinate value. v in the mathematical expression (2) is a vehicle speed, and flag is a determination value (0: usable, 1: unusable) of data usability.

$$\begin{matrix}{P}_{τ - 2} ( τ - {a}_{τ - 2} , τ - {a}_{τ - 2 } + 1 , Λ , τ , τ + 1 , τ + 2 , Λ , τ + {b}_{τ - 2} ) \\ {P}_{τ - 1} ( τ - {a}_{τ - 1} , τ - {a}_{τ - 1} + 1 , Λ , τ , τ + 1 , τ + 2 , Λ , τ + {b}_{τ - 1} ) \\ {P}_{τ} ( τ - {a}_{τ} , τ - {a}_{τ} + 1 , Λ , τ , τ + 1 , τ + 2 , Λ , τ + {b}_{τ} ) \\ {P}_{τ + 1} ( τ - {a}_{τ + 1} , τ - {a}_{τ + 1} + 1 , Λ , τ , τ + 1 , τ + 2 , Λ , τ + {b}_{τ + 1} ) \\ {P}_{τ + 2} ( τ - {a}_{τ + 2} , τ - {a}_{τ + 2} + 1 , Λ , τ , τ + 1 , τ + 2 , Λ , τ + {b}_{τ + 2} ) & ( 1 ) \\ P ( τ ) = [ \begin{matrix}x \\ y \\ v \\ flag\end{matrix} ] ( τ - {a}_{τ} , τ - {a}_{τ} + 1 , Λ , τ , τ + 1 , τ + 2 , Λ , τ + {b}_{τ} ) & ( 2 )\end{matrix}$$

In this case, the control ECU 5 selects a value (selection value K) to be used for calculating a driving control variable at each time from among the time-series data of the target trajectory P in accordance with the first selection condition. Here, when it is suitable for the mathematical expressions used in processes to select data of the last two times τ−1 and τ−2 with reference to the time τ (for example, current time), for example, as expressed by the following mathematical expression (3), a condition for selecting a value P(τ) at the reference time τ and the last two values P(τ−1) and P(τ−2) through a quadratic finite impulse response (FIR) filter is employed as the first selection condition.

f(P(τ),P(τ−1),P(τ−2)) (3)

Furthermore, it is also applicable that, in consideration of the determination value flag of data usability, a condition for selecting the last two data with reference to the reference time τ from among data of which the flag is 0 is employed as the first selection condition. In this case, the FIR filter expressed by the following mathematical expression (4) may be used. In addition, it is also applicable that a condition for selecting data of which the flag is 0 from among the data range of the reference time τ is employed as the first selection condition. Examples of the first selection condition are described above; however, the first selection condition is not limited to those described above. A condition appropriate for the details of processes, a controlled object, specifications and other various factors is selected as the first selection condition.

f(P(τ),P(τ−1),P(τ−2)) (4)

In addition, in the present embodiment, the input ECU 3 may generate input time-series data N that contain a future input value. Specifically, the input ECU 3 estimates a future input value through a predetermined computation program on the basis of a current input value input from the sensor 2 and a saved previous input value. The input ECU 3 generates input time-series data N that contain a future input value on the basis of the current input value, the saved previous input value and the estimated future input value.

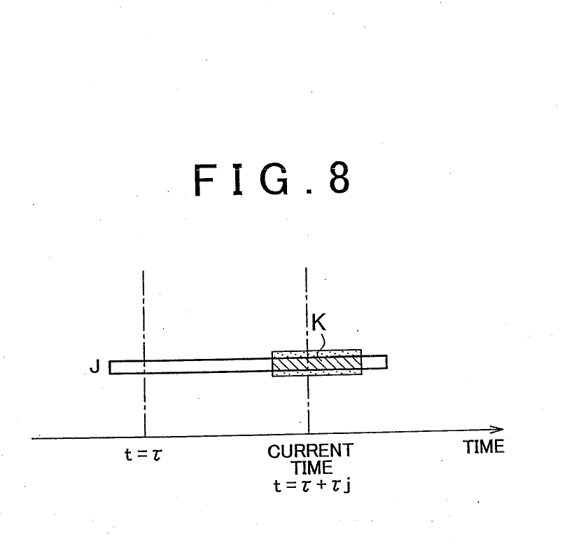

With the above configuration, as shown in FIG. 8, the processing ECU 4 generates the intermediate computation value time-series data J that contain a future intermediate computation value corresponding to a future input value to widen a selectable range for a selection value K, so it is possible to calculate a further appropriate control variable according to the details of control. Note that such selection of data according to the first selection condition is not limited to the case where data are selected from among the intermediate computation value time-series data J, but data may also be selected from among time-series data during processes in the processing ECU 4.

Furthermore, in the present embodiment, each ECU may output a set of a plurality of pieces of time-series data to the following ECU. Specifically, the input ECU 3 generates a plurality of pieces of input time-series data N that temporally partially overlap, and outputs a set of these plurality of pieces of input time-series data N and times τ−3 to τ+2 (τ is an arbitrary reference time) corresponding to the respective pieces of input time-series data N to the processing ECU 4. Note that times corresponding to the respective pieces of input time-series data N may be, for example, times at which the pieces of input time-series data N are generated, or the like.

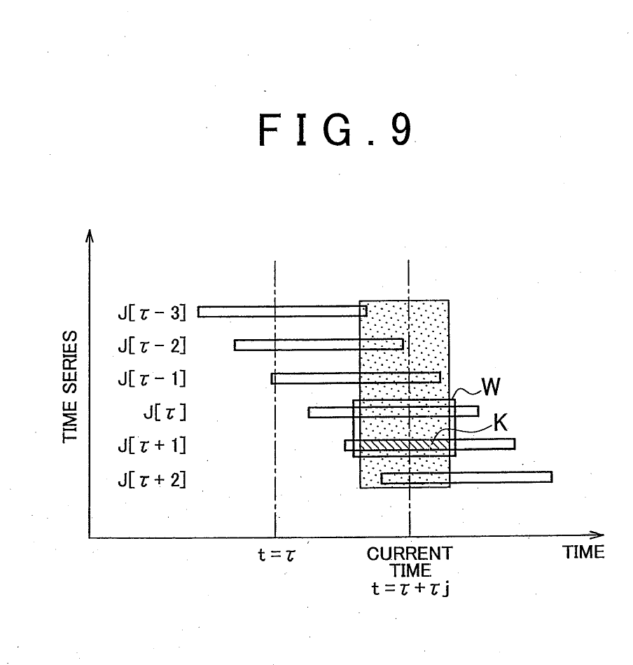

Then, as shown in FIG. 9, the processing ECU 4 generates a set of a plurality of pieces of intermediate computation value time-series data J[τ−3] to J[τ−2] on the basis of the plurality of pieces of input time-series data N and the times τ−3 to τ+2 corresponding to the respective pieces of input time-series data N, output from the input ECU 3. After that, the control ECU 5 selects a selection value K in accordance with the above described first selection condition from among the set of the pieces of intermediate computation value time-series data J[τ−3] to J[τ+2]. Note that, in this case, it is applicable that a selection range W is selected in accordance with a predetermined range selection condition, and then a selection value K is specified from the selection range W. Then, the control ECU 5 calculates control variables that are control targets on the basis of the selection value K.

With the above configuration, by computing a plurality of pieces of time-series data at the same time, the computation result excluding variations in processing delay time in input processings of various input values may be output to the following ECU, so it is possible to output control variables having further high control accuracy.

### Second Embodiment

Next, a control target processing system 11 according to a second embodiment will be described with reference to the accompanying drawings. The control target processing system 11 according to the second embodiment mainly differs from that of the first embodiment in that control variables according to input values from a plurality of sensors 21 to 26 is output, the function of the processing ECU 41 and the function of the control ECU 51.

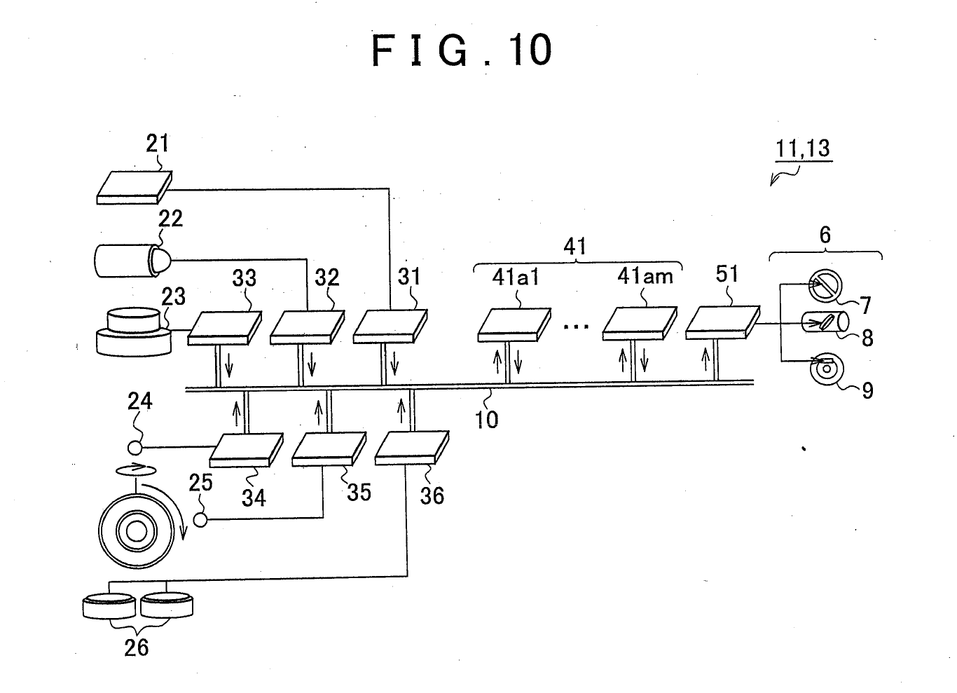

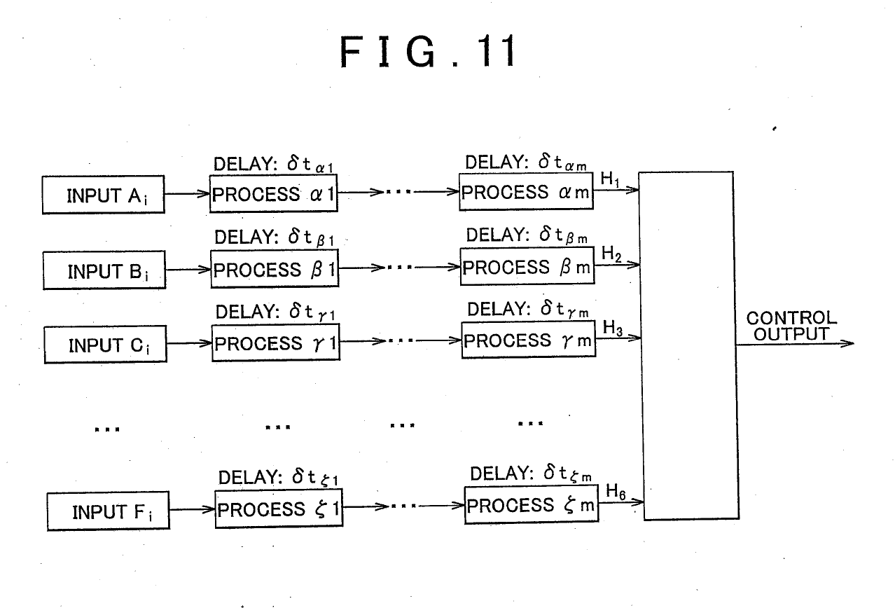

As shown in FIG. 10 and FIG. 11, the control target processing system 11 according to the present embodiment includes a yaw/G sensor 21, an image sensor 22, a radar sensor 23, a steering angle sensor 24, a vehicle speed sensor 25 and a global positioning system (GPS) detecting unit 26. Furthermore, the control target processing system 11 includes input ECUs 31 to 36, the processing ECU 41 and the control ECU 51. Note that the input ECUs 31 to 36 function as a first generating unit, the processing ECU 41 functions as a second generating unit, and the control ECU 51 functions as a selecting unit and an output unit. In addition, the input ECUs 31 to 36, the processing ECU 41 and the control ECU 51 are electrically connected to one another through a vehicle LAN 10, and share a system timer for acquiring time information.

The yaw/G sensor 21 detects the yawing and acceleration of the vehicle. The yaw/G sensor 21 is electrically connected to the input ECU 31. The yaw/G sensor 21 outputs information of the detected yawing and acceleration of the vehicle to the input ECU 31 as a yaw/G input value Ai. The image sensor 22 captures an image around the vehicle. The image sensor 22 is electrically connected to the input ECU 32. The image sensor 22 outputs information of the captured image around the vehicle to the input ECU 32 as an image input value Bi.

The radar sensor 23 detects an obstacle, such as another vehicle, present around the vehicle. The radar sensor 23 is electrically connected to the input ECU 33. The radar sensor 23 outputs information of the detected obstacle to the input ECU 33 as an obstacle input value Ci. The steering angle sensor 24 detects the steering angle of a steering wheel (the direction of tires). The steering angle sensor 24 is electrically connected to the input ECU 34. The steering angle sensor 24 outputs information of the detected steering angle to the input ECU 34 as a steering angle input value Di.

The vehicle speed sensor 25 detects a vehicle speed from the number of rotations of wheels. The vehicle speed sensor 25 is electrically connected to the input ECU 35. The vehicle speed sensor 25 outputs information of the detected vehicle speed to the input ECU 35 as a vehicle speed input value Ei. The GPS detecting unit 26 receives radio waves from a plurality of GPS satellites to detect the location of the vehicle. The GPS detecting unit 26 is electrically connected to the input ECU 36. The GPS detecting unit 26 outputs information of the detected location of the vehicle to the input ECU 36 as a location input value Fi.

The input ECUs 31 to 36 respectively acquire various input values Ai to Fi input from the various sensors 21 to 26. In addition, the input ECUs 31 to 36 respectively acquire input times of the various input values Ai to Fi on the basis of time information acquired from the system timer. The input ECUs 31 to 36 respectively save the various input values Ai to Fi and the input times corresponding to the various input values Ai to Fi. The input ECUs 31 to 36 respectively estimate various future input values Ai to Fi on the basis of the saved current and previous input values Ai to Fi. The input ECUs 31 to 36 respectively generate pieces of input time-series data N₁ to N₆ that respectively contain the estimated future input values Ai to Fi on the basis of the saved current and previous input values Ai to Fi and the estimated future input values Ai to Fi. The input ECUs 31 to 36 output the generated pieces of input time-series data N₁ to N₆ to the processing ECU 41.

The processing ECU 41 acquires the pieces of input time-series data N₁ to N₆ input from the input ECUs 31 to 36. The processing ECU 41 generates pieces of intermediate computation value time-series data J₁ to J₆, which are pieces of time-series data of intermediate computation values corresponding to the various input values Ai to Fi, on the basis of the input time-series data N₁ to N₆. The processing ECU 41 is formed of a plurality of ECUs 41a1 to 41am. Note that the plurality of ECUs 4a1 to 4am function as a processing unit according to the aspect of the invention. In the processing ECU 41, processes α1 to αm in the respective ECUs 41a1 to 41am are sequentially executed on the pieces of input time-series data N₁ to N₆ to thereby generate the pieces of intermediate computation value time-series data J₁ to J₆. At this time, data are exchanged in the format of time-series data among the ECUs 41a1 to 41am. The processing ECU 41 outputs the generated pieces of intermediate computation value time-series data J₁ to J₆ to the control ECU 51.

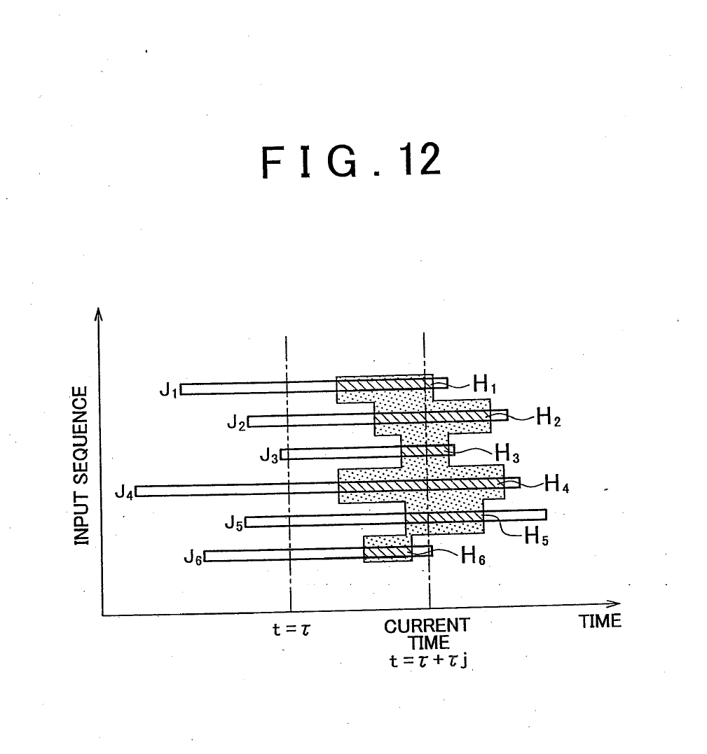

The control ECU 51 acquires the pieces of intermediate computation value time-series data J₁ to J₆ input from the processing ECU 41. The control ECU 51 respectively selects selectable data ranges H₁ to H₆ (corresponding to a set of selection values K in the first embodiment) from among the pieces of intermediate computation value time-series data J₁ to J₆ corresponding to the various input values Ai to Fi (see FIG. 12).

At this time, the control ECU 51 selects the selectable data ranges H₁ to H₆ in accordance with a predetermined second selection condition. The above second selection condition may be various. For example, an appropriate condition is selected as the second selection condition in accordance with a purpose, such as reduction in temporal variations of the input value, compatibility with sensor characteristic and removal of adverse effect of a processing delay time. An example of the second selection condition is a condition for selecting data ranges that correspond to necessary ranges for calculating control variables around a current time τ+τj and that are suitable for the mathematical expressions of the following processes (control variable calculation process) as the selectable data ranges H₁ to H₆.

The control ECU 51 calculates control variables on the basis of the pieces of intermediate computation value data within the respective selectable data ranges H₁ to H₆. The control ECU 51 outputs the calculated control variable as a control target to the actuators 6.

Next, the operation of the ECUs of the thus configured control target processing system 11 will be described with reference to the accompanying drawings.

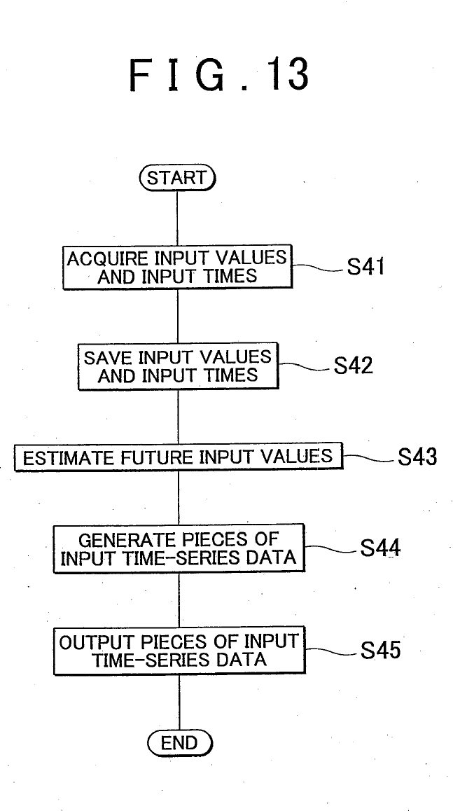

As shown in FIG. 13, the input ECUs 31 to 36 acquire the detected information of the various sensors 21 to 26 as input values, and acquire input times of the input values on the basis of time information acquired from the system timer (S41). Subsequently, the input ECUs 31 to 36 respectively save the input values and the corresponding input times (S42).

Subsequently, the input ECUs 31 to 36 estimate various future input values on the basis of the saved current and previous input values Ai to Fi and input times (S43). After that, the input ECUs 31 to 36 respectively generate pieces of input time-series data N₁ to N₆ that respectively contain the various future input values (S44). The input ECUs 31 to 36 respectively output the generated pieces of input time-series data N₁ to N₆ to the processing ECU 41 (S45). After that, the process ends.

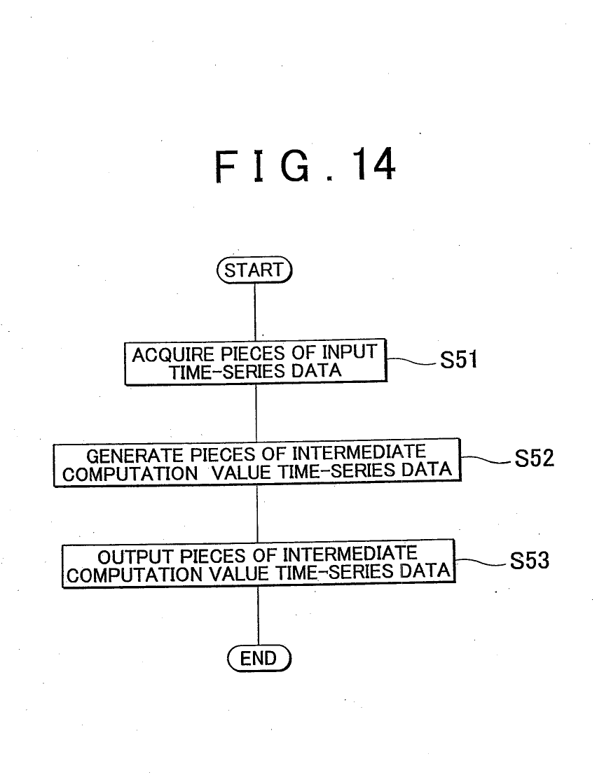

As shown in FIG. 14, the processing ECU 41 acquires the pieces of input time-series data N₁ to N₆ output from the respective input ECUs 31 to 36 (S51). After that, the processing ECU 41 generates pieces of intermediate computation value time-series data J₁ to J₆ corresponding to the various input values Ai to Fi on the basis of the pieces of input time-series data N₁ to N₆ (S52). At this time, as shown in FIG. 11 and FIG. 12, there occurs a temporal deviation between the intermediate computation value time-series data J₁ and the intermediate computation value time-series data J₂ because of the accumulated influence of a difference in time consumed for processes (for example, a difference between a time consumed for computing the yawing and acceleration of the vehicle and a time consumed for processing an image), a difference in input timing from the sensors and differences between irregular processing delay times δt_{α1} to δt_{αm} and δt_{β1} to δt_{βm} in the respective ECUs 41a1 to 41am. Similarly, there also occur temporal deviations among the pieces of intermediate computation value time-series data J₁ to J₆. The processing ECU 41 outputs the generated pieces of intermediate computation value time-series data J₁ to J₆ to the control ECU 51 (S53). After that, the process ends.

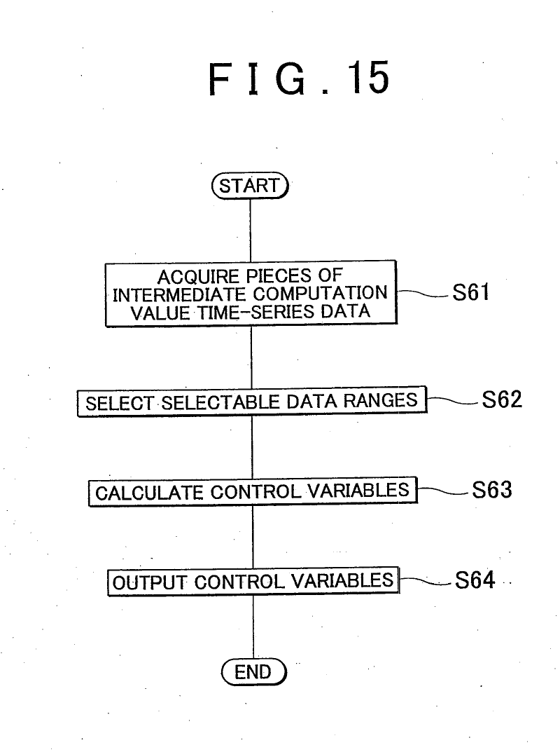

As shown in FIG. 15, the control ECU 51 acquires the pieces of intermediate computation value time-series data J₁ to J₆ input from the processing ECU 41 (S61). The control ECU 51 respectively selects selectable data ranges H₁ to H₆ used for calculating control variables from among the pieces of intermediate computation value time-series data J₁ to J₆ corresponding to the various input values Ai to Fi (S62). The control ECU 51 calculates control variables on the basis of the pieces of data within the respective selectable data ranges H₁ to H₆ (S63). The control ECU 51 outputs the calculated control variable as a control target to the actuators 6 (S64). After that, the process ends.

With the above described control target processing system 11, when control variables are output as control targets on the basis of a plurality of types of input values Ai to Fi, selectable data ranges H₁ to H₆ used for calculating the control variable are respectively selected from among the plurality of types of intermediate computation value time-series data J₁ to J₆ in accordance with the second selection condition. Thus, with the control target processing system 11, even when irregular processing delay times δt_{α1} to δt_{ζm}, occur in a plurality of processes, selectable data ranges H₁ to H₆ suitable for calculating control variables may be flexibly selected in accordance with an actual time required for processes, so it is possible to improve the reliability of control over the controlled object.

Note that the second selection condition is not limited to the above described conditions. For example, a condition for selecting a combination of selectable data ranges suitable for the mathematical expressions used in processes may be employed as the second selection condition. Specifically, for a plurality of pieces of intermediate computation value time-series data x, y, z, when it is apparently suitable for the mathematical expressions used in the following processes to select data at a current time τ and data at the two previous times τ−1 and τ−2 for the intermediate computation value time-series data x, data at the second to fourth previous times τ−2, τ−3 and τ−4 for the intermediate computation value time-series data y, and predictive data at one future time τ+1, data at a current time τ and data at the one previous time τ−1 for the intermediate computation value time-series data z, for example, an FIR filter expressed by the following mathematical expression (5) may be employed as the second selection condition.

f(x(τ),x(τ−1),x(τ−2),y(τ−2),y(τ−3),y(τ−4),z(τ+1),z(τ),z(τ−1)) (5)

In addition, the second selection condition may be a condition for selecting data prepared at the time of processes so that temporal variations among various data is reduced. Specifically, it is assumed that, for the pieces of intermediate computation value time-series data x, y, z, as shown in the following Table 1, the intermediate computation value time-series data x contain three times delay data (that is, data x(τ−3) at a third delay time τ−3 from a current time τ are acquired), the intermediate computation value time-series data y contain one time delay data and the intermediate computation value time-series data z contain no delay data. At this time, an FIR filter expressed by the following mathematical expression (6) may be employed as the second selection condition so as to reduce temporal variations among the various data. Selectable data ranges in this case are shaded in Table 1.

TABLE 1
(6)
f (x(τ), x(τ − 1), x(τ − 2), y(τ − 2), y(τ − 3), y(τ − 4), z(τ + 1), z(τ), z(τ − 1))

| INDEX | −5 | −4 | −3 | −2 | −1 | 0 |
|---|---|---|---|---|---|---|
| DATA x | τ-8 | τ-7 | 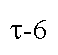 | 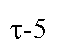 | 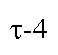 | τ-3 |
| DATA y | 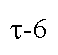 | 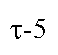 | 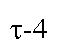 | τ-3 | τ-2 | τ-1 |
| DATA z | τ-5 | τ-4 | τ-3 | 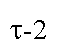 | 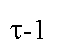 | 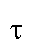 |

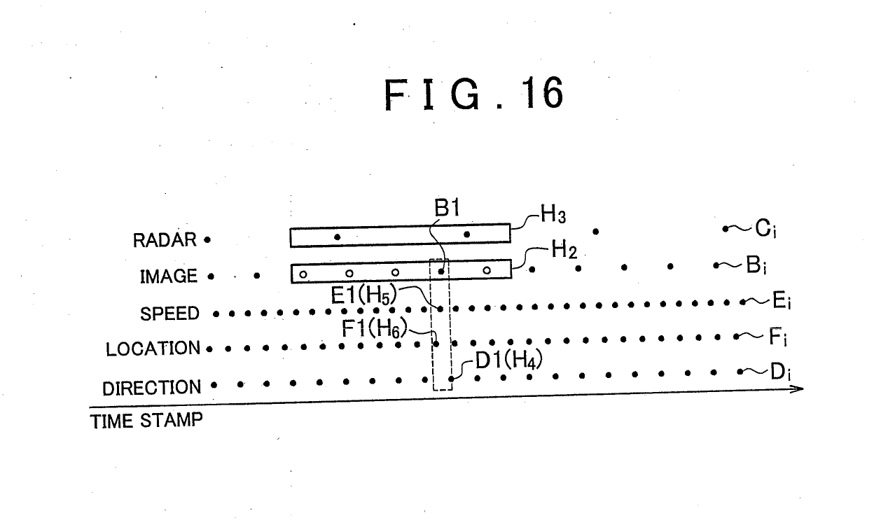

Next, a specific example of a case where selectable data ranges are selected in accordance with the second selection condition will be described with reference to FIG. 16. In FIG. 16, solid dots indicate the above described various input values Bi to Fi, and the abscissa axis represents a time stamp (time associated with each input value by the system timer). In addition, outline dots indicate image input values Bi that have no contrast of an image and that are not effective as a computed object among the image input values Bi.

In this case, the selectable data range H₃ with reference to a current time is initially selected from among the input time-series data N₃, which are time-series data of the obstacle input value Ci input from the radar sensor 23, in accordance with the second selection condition. Subsequently, the selectable data range H₂, which is a range temporally corresponding to the selectable data range H₃, is selected from among the input time-series data N₂, which are time-series data of the image input value Bi input from the image sensor 22.

Then, an image input value B1 that has a contrast (image input value indicated by a solid dot) is extracted from among the image input values Bi within the selectable data range H₂. After that, a vehicle speed input value E1 that is temporally the closest to the image input value B1 is selected as a selectable data range H₅ from among the input time-series data N₅, which are time-series data of the vehicle speed input value Ei input from the vehicle speed sensor 25. Similarly, a steering angle input value D1 that is temporally the closest to the image input value B1 is selected as a selectable data range H₄ from among the input time-series data N₄, which are time-series data of the steering angle input value Di input from the steering angle sensor 24. In addition, a location input value F1 that is temporally the closest to the image input value B1 is selected as a selectable data range H₆ from among the input time-series data N₆, which are time-series data of the location input value Fi input from the GPS detecting unit 26.

Through the above described procedure, the selectable data ranges H₂ to H₆ having small temporal variations as shown in FIG. 16 are acquired in accordance with the second selection condition for selecting data prepared at the time of processes so as to reduce temporal variations among various data. By calculating control variables on the basis of the thus selected selectable data ranges H₂ to H₆, the control variables having small influence of temporal variations among various data with high control accuracy is output. Moreover, an image input value of a faint image having no contrast is not used, so it is possible to improve the reliability of control over the controlled object.

Examples of the second selection condition are described above; however, the second selection condition is not limited to those described above. A condition appropriate for the details of processes, a controlled object, specifications and other various factors is selected as the second selection condition. In addition, such selection of data ranges according to the second selection condition is not limited to the case where the data ranges are used for calculating control variables, but the selection of data ranges may also be appropriately used in another computation where necessary.

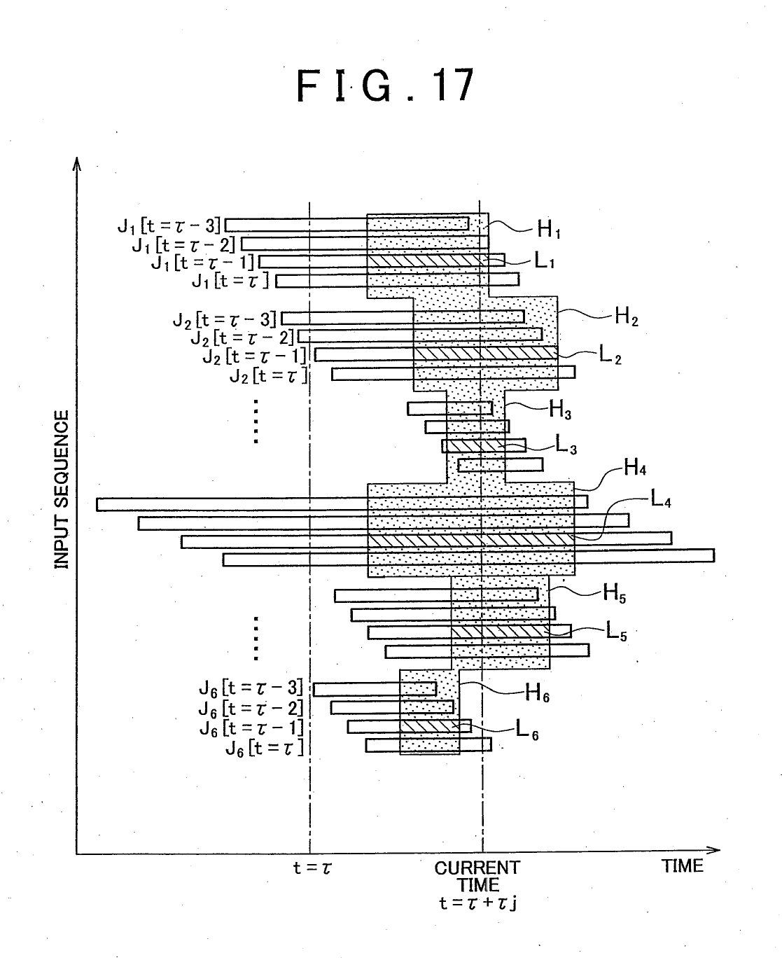

In addition, as shown in FIG. 17, in the present embodiment, each ECU may output a set of a plurality of pieces of time-series data to the following ECU. In this case, the input ECU 31 generates a plurality of pieces of input time-series data N₁ that temporally partially overlap. The input ECU 31 sets corresponding times τ−3 to τ(τ is an arbitrary reference time) for each of the plurality of pieces of input time-series data N₁. The input ECU 31 outputs a set of these plurality of pieces of input time-series data N₁[τ−3] to N₁[τ] to the processing ECU 41.

The processing ECU 41 generates a set of pieces of intermediate computation value time-series data J₁[τ−3] to J₁[τ] on the basis of the set of pieces of input time-series data N₁[τ−3] to N₁[τ] output from the input ECU 31. The processing ECU 41 outputs the generated set of pieces of intermediate computation value time-series data J₁[τ−3] to J₁[τ] to the control ECU 51.

Similarly, the input ECUs 32 to 36 respectively generate a plurality of pieces of input time-series data N₂ to N₆, associate the plurality of pieces of input time-series data N₂ to N₆ with times τ−3 to τ and then output a set of pieces of input time-series data N₂[τ−3] to N₂[τ], . . . , N₆[τ−3] to N₆[τ] to the processing ECU 41. The processing ECU 41 generates a set of pieces of intermediate computation value time-series data J₂[τ−3] to J₂[τ], . . . , J₆[τ−3] to J₆[τ] on the basis of the set of pieces of input time-series data N₂[τ−3] to N₂[τ], . . . , N₆[τ−3] to N₆[τ]. The processing ECU 41 outputs the generated set of pieces of intermediate computation value time-series data J₂[τ−3] to J₂[τ], . . . , J₆[τ−3] to J₆[τ] to the control ECU 51.

The control ECU 51 respectively selects selectable data ranges H₁ to H₆ from among the set of J₁[τ−3] to J₁[τ], . . . , J₆[τ−3] to J₆[τ] output from the input ECUs 31 to 36 in accordance with the above described second selection condition. Data ranges at the same timing with reference to a current time are selected as these selectable data ranges H₁ to H₆. Then, the control ECU 51 calculates control variables on the basis of pieces of selected data L₁ to L₆ that are further selected respectively from among the selectable data ranges H₁ to H₆ in accordance with a predetermined selection condition.

With the thus configured control target processing system 11, by computing a set of a plurality of pieces of time-series data, deviations or variations in processing delay time in input processings of various input values are excluded, and the computation results according to an actual time consumed for processes may be output to the following ECU, so it is possible to output control variables having further high control accuracy.

### Third Embodiment

Next, a control target processing system 12 according to a third embodiment will be described with reference to the accompanying drawings. The control target processing system 12 according to the third embodiment mainly differs from that of the first embodiment in that the lengths (time lengths) of time-series data input to the control ECU 5 are set in accordance with processing delay times and the input time-series data N contain a future input value.

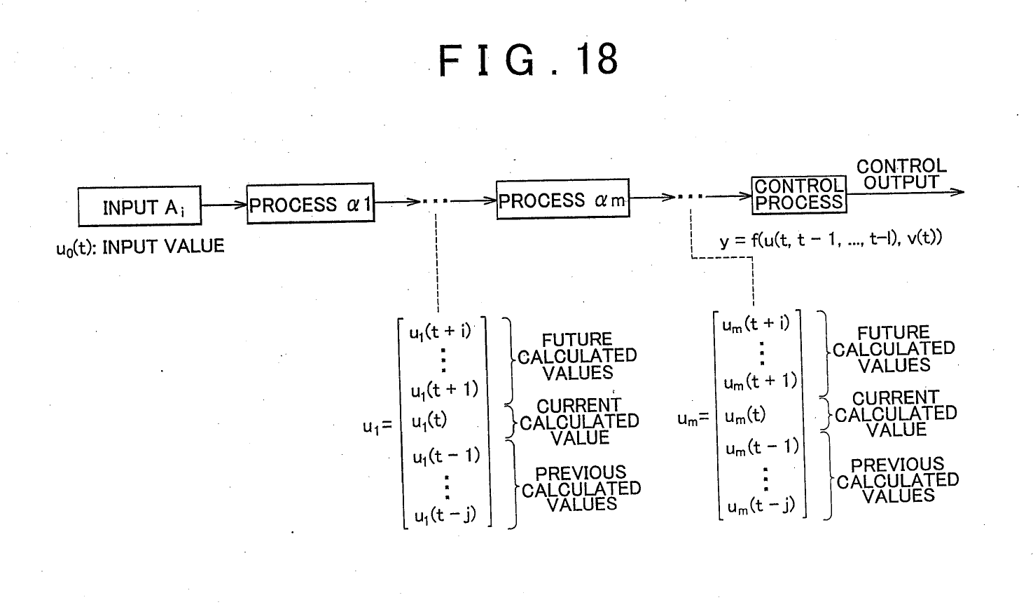

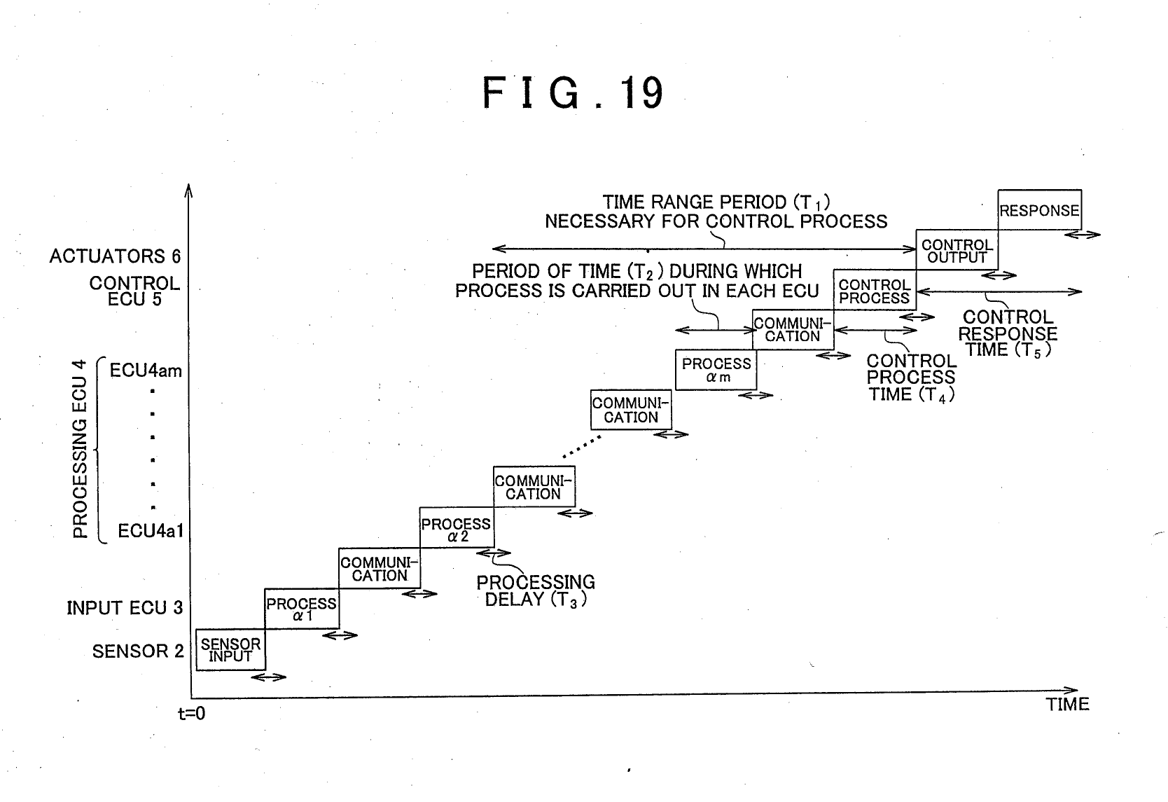

As shown in FIG. 1, FIG. 18 and FIG. 19, the control target processing system 12 according to the third embodiment has the same configuration as that of the control target processing system 1 according to the first embodiment. u₀(t) shown in FIG. 18 indicates an input value from the sensor 2 at time t, and u₁ indicates time-series data of the computation result (computation result in an initial process α1) of an ECU 4a1 that constitutes the processing ECU 4. In addition, uₘ indicates time-series data of a computation result (computation result in the mth process αm) of an ECU 4am that constitutes the processing ECU 4, and corresponds to intermediate computation value time-series data J input to the control ECU 5. y indicates control variables output from the control ECU 5 to the actuators 6.

In addition, T₁ shown in FIG. 19 indicates a time-series range necessary for control process in the control ECU 5. T₂ indicates processing times in the input ECU 3 and the respective ECUs 4a1 to 4am that constitute the processing ECU 4. T₃ indicates processing delay times in the respective ECUs 4a1 to 4am. In addition, T₄ indicates a processing period of time (control process time) in the control ECU 5, and T₅ indicates a period of time (control response time) consumed for the actuators 6 to respond to the control variable and then complete driving operation according to the control variable from when the control ECU 5 outputs the control variable.

The input ECU 3 in the control target processing system 12 is electrically connected to the sensor 2, and acquires an input value u₀(t) at time t from the sensor 2. In addition, the input ECU 3 acquires an input time of the input value on the basis of time information acquired from the system timer. The input ECU 3 saves the input value and the corresponding input time.

The input ECU 3 estimates future input values u₀(t+1) to u₀(t+i) (i is an arbitrary natural number) on the basis of the saved current input value u₀(t), previous input values u₀(τ−1) to u₀(t−j) (j is an arbitrary natural number) and input times. Then, the input ECU 3 generates input time-series data N that contain the estimated various future input values. At this time, the input ECU 3 predicts a data length necessary for the process α1 in the ECU 4a1, a period of time consumed for the process α1 and the processing delay time, and then generates input time-series data N having a length corresponding to the predicted results. The input ECU 3 outputs the generated input time-series data N to the processing ECU 4.

The ECU 4a1 of the processing ECU 4 generates time-series data u₁, resulting from the process α1, from the input time-series data N. At this time, the ECU 4a1 predicts a data length necessary for process α2 in the subsequent ECU 4a2, a period of time consumed for the process α2 and the processing delay time in the process α2, and then generates time-series data having a length corresponding to the predicted results. The ECU 4a1 outputs the generated time-series data to the ECU 4a2.

Similarly, processes α2 to αm−1 are executed in the respective ECUs 4a2 to 4am−1 that constitute the processing ECU 4, and the time-series data uₘ₋₁ of the computation result generated by the ECU 4am−1 are output to the ECU 4am. The ECU 4am predicts a data length necessary for control variable calculation process in the subsequent control ECU 5, a period of time consumed for control variable calculation process and the processing delay time. The ECU 4am generates time-series data uₘ of the computation result (intermediate computation value time-series data J) so that the length T_{A} satisfies the following mathematical expression (7). The ECU 4am outputs the generated time-series data uₘ having the length T_{A} to the control ECU 5.

T_{A}=T₁ΣT₂+ΣT₃ (7)

The control ECU 5 acquires the time-series data uₘ of the computation result input from the ECU 4am. The control ECU 5 calculates control variables on the basis of the acquired time-series data uₘ of the computation result. The control ECU 5 outputs the calculated control variable as a control target to the actuators 6.

With the above described control target processing system 12, the length of time-series data input to the subsequent ECU is set depending on a processing delay time that irregularly fluctuates. By so doing, it is possible to reduce the length of data while ensuring the length of the data necessary for control process. Thus, it is possible to reduce the processing load and increase the processing speed.

In addition, the length T_{A} of time-series data uₘ of the computation result may be set so as to satisfy the following mathematical expression (8). In this case, it is possible to calculate control variables at the time when the control variable calculation process is completed.

T_{A}=T₁+ΣT₂+ΣT₃+T₄ (8)

Alternatively, the length T_{A} of time-series data uₘ of the computation result may be set so as to satisfy the following mathematical expression (9). In this case, by predicting control variables up to the timing at which the actuators 6 actually operate, it is possible to calculate a further appropriate control variable according to an up-to-date system status.

T_{A}=T₁+ΣT₂+ΣT₃+T₄+T₅ (9)

Note that the length T_{A} of time-series data uₘ is described specifically taking the mathematical expressions (7) to (9) as examples; instead, a data length may also be set for the other time-series data u₁ to uₘ₋₁ on the basis of the same concept.

### Fourth Embodiment

Next, a control target processing system 13 according to a fourth embodiment will be described with reference to the accompanying drawings. The control target processing system 13 according to the fourth embodiment mainly differs from that of the second embodiment in that an input value from a selected sensor is directly input to the control ECU 51.

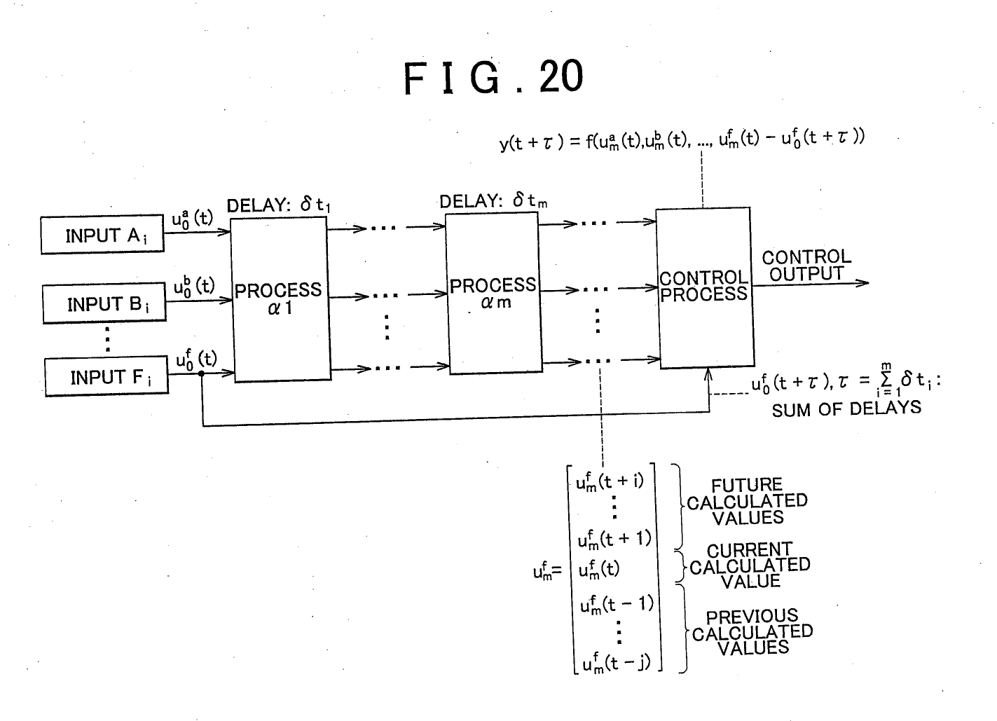

As shown in FIG. 10 and FIG. 20, the control target processing system 13 according to the present embodiment has the same configuration as that of the control target processing system 11 according to the second embodiment. u^{a}₀(t) shown in FIG. 20 is a yaw/G input value Ai at time t, which has not been subjected to processes in the processing ECU 41. u^{b}₀(t) to u^{f}₀(t) are various input values Bi to Fi at time t, which have not been subjected to processes in the processing ECU 41. u^{a}ₘ is intermediate computation value time-series data J₁ generated from input time-series data N₁, which are time-series data of the yaw/G input value Ai, and is a computation result that has passed processes α1 to αm in the processing ECU 41. The u^{a}ₙ, contains input values of a future calculation value u^{a}ₘ(t+i) to a previous calculation value u^{a}ₘ(t−j) (i and j are arbitrary values). In addition, δt₁ denotes a processing delay time in the process α1, δtₘ denotes a processing delay time in the process αm. In addition, the sum Σδt of processing delay times of the respective processes α1 to αm is expressed by the following mathematical expression (10). y is control variables output from the control ECU 51 to the actuators 6.

$${u}_{0}^{f} ( t + τ ) , τ = {\sum }_{i = 1}^{m} δ {t}_{i} \qquad ( 10 )$$

Hereinafter, a case where a location input value Fi of the GPS detecting unit 26 is directly input to the control ECU 51 without passing the processing ECU 41 as the input value of a selected sensor will be described. Note that such a selected sensor is selected depending on the details of control and may be not one but multiple.

The input ECUs 31 to 35 in the control target processing system 13 generate pieces of input time-series data N₁ to N₆, which are pieces of time-series data of the various input values Ai to Ei (u^{a}₀ to u^{e}₀) input from the various sensors 21 to 25, and output the pieces of input time-series data N₁ to N₅ to the processing ECU 41. The input ECU 36 generates input time-series data N₆, which are time-series data of the location input value Fi(u^{f}₀) output from the GPS detecting unit 26. In addition, the input ECU 36 outputs the generated input time-series data N₆ to the processing ECU 41, and outputs the up-to-date location input value Fi, output from the GPS detecting unit 26, to the control ECU 51.

The processing ECU 41 generates pieces of intermediate computation value time-series data J₁ to J₆ on the basis of the pieces of input time-series data N₁ to N₆ output from the input ECU 31 to 36. The processing ECU 41 outputs the generated intermediate computation value time-series data J₁ to J₆ to the control ECU 51.

The control ECU 51 acquires the pieces of intermediate computation value time-series data J₁ to J₆ input from the processing ECU 41, and acquires the up-to-date location input value Fi input from the input ECU 36. The control ECU 51 respectively selects selectable data ranges H₁ to H₆ from among the pieces of intermediate computation value time-series data J₁ to J₆, corresponding to the various input values Ai to Fi in accordance with the above described second selection condition (see FIG. 12).

The control ECU 51 calculates control variables on the basis of data within the respective selectable data ranges H₁ to H₆ and the up-to-date location input value Fi. The control ECU 51 outputs the calculated control variable as a control target to the actuators 6.

With the above described control target processing system 13, by directly inputting an up-to-date location input value Fi to the control ECU 51 that executes final process, the influence of temporal deviations in input and output due to processing times in the processes α1 to αm and the sum Σδt of processing delay times may be reduced, so it is possible to output control variables according to an up-to-date situation. That is, for example, an up-to-date vehicle location as the result of driving control may be recognized on the basis of the location input value Fi, so feedback control based on the up-to-date situation is possible. By so doing, it is possible to reduce the influence of an overshoot phenomenon, or the like. Note that a selected sensor may be connected to only the control ECU 51 depending on the details of control.

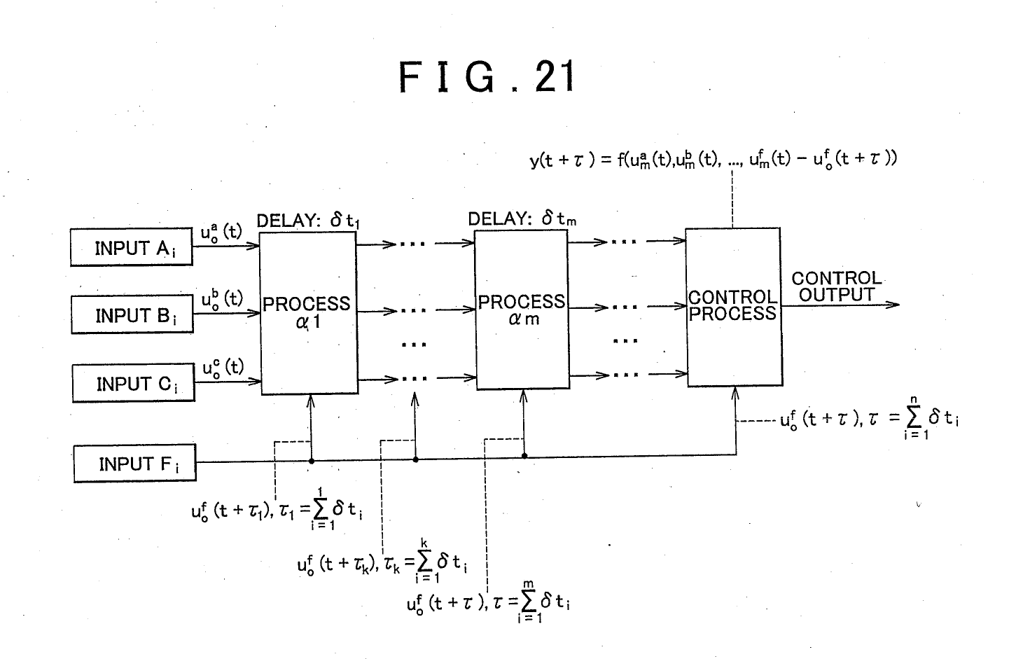

In addition, in the present embodiment, as shown in FIG. 21, a location input value Fi from the GPS detecting unit 26 as the selected sensor may be directly used in the processes α1 to αm in the processing ECU 41 and control process in the control ECU 51.

In this case, each process is executed using an up-to-date location input value Fi at that moment, so it is not necessary to consider a processing delay time in each process stage in the final process in the control ECU 51, and it is possible to improve the flexibility of system design. As a result, it is possible to minimize a processing delay time in a complex system that executes feedback of each of a plurality of input values, mutual utilization of a plurality of input values, or the like.

### Fifth Embodiment

Next, a control target processing system 14 according to a fifth embodiment will be described with reference to the accompanying drawings. The fifth embodiment is a specific example that includes the features of the first, second and fourth embodiments.

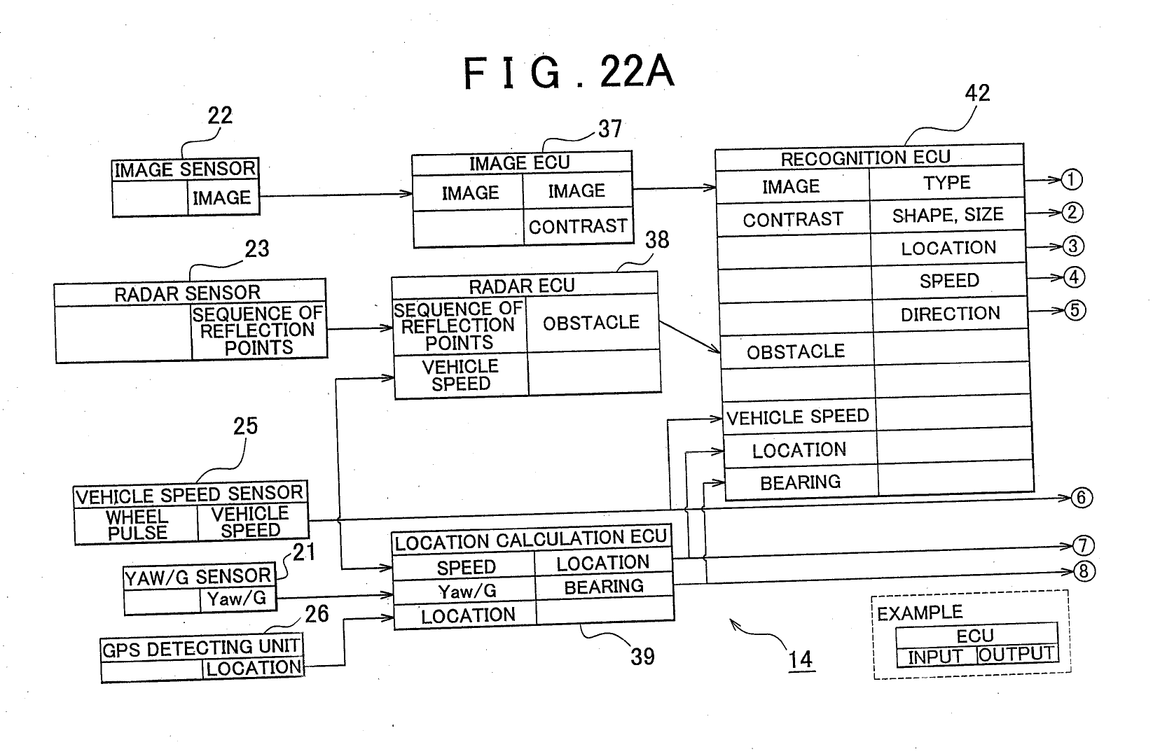

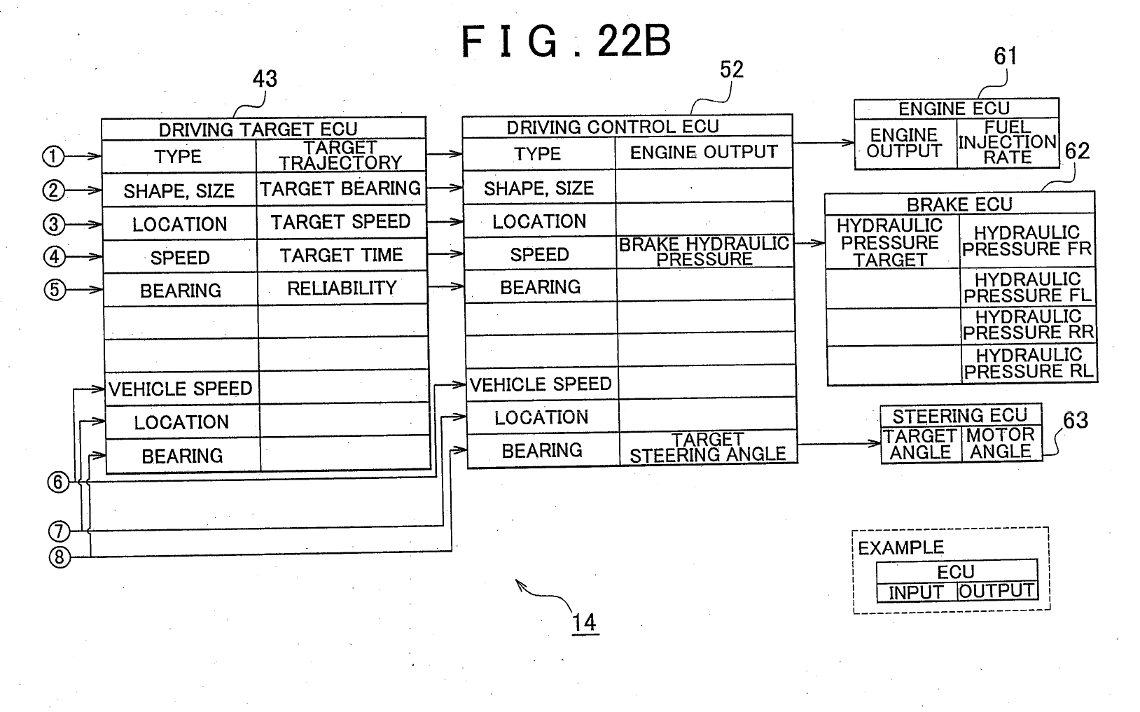

As shown in FIGS. 22A and 22B, the control target processing system 14 includes a yaw/G sensor 21, an image sensor 22, a radar sensor 23, a vehicle speed sensor 25 and a GPS detecting unit 26. Furthermore, the control target processing system 14 includes an image ECU 37, a radar ECU 38 and a location calculation ECU 39. In addition, the control target processing system 14 includes a recognition ECU 42, a driving target ECU 43, a driving control ECU 52, an engine ECU 61, a brake ECU 62 and a steering ECU 63. These ECUs are electrically connected to one another through a vehicle LAN 10 (see FIG. 10). In addition, the ECUs share a system timer for acquiring time information through the vehicle LAN 10. Note that the image ECU 37, the radar ECU 38 and the location calculation ECU 39 function as a first generating unit, the recognition ECU 42 and the driving target ECU 43 function as a second generating unit, and the driving control ECU 52 functions as a selecting unit and an output unit.

Note that, as an example shown in FIGS. 22A and 22B, items input to each sensor or each ECU are shown at the left field under the name of the sensor or the ECU, and items output from the sensor or the ECU are shown at the right field.

In addition, the recognition ECU 42, the driving target ECU 43 and the driving control ECU 52 are electrically connected to the vehicle speed sensor 25, and directly receive a vehicle speed input value Ei from the vehicle speed sensor 25. In the present embodiment, a combination of the image ECU 37, the radar ECU 38, the location calculation ECU 39 and the recognition ECU 42 corresponds to the input ECUs 31 to 36 and the processing ECU 41 in the second embodiment.

The image ECU 37 is electrically connected to the image sensor 22. The image ECU 37 acquires an image input value Bi regarding an image around the vehicle from the image sensor 22. In addition, the image ECU 37 acquires an input time of the image input value Bi on the basis of time information acquired from the system timer. The image ECU 37 saves the image input value Bi and the corresponding input time.

The image ECU 37 calculates the contrast of the image of the acquired image input value Bi through a predetermined contrast calculation process. The image ECU 37 generates time-series data (corresponding to the input time-series data N₂ in the second embodiment) of the image input value Bi of which the contrast has been calculated and then outputs the time-series data of the image input value Bi to the recognition ECU 42.

The radar ECU 38 is electrically connected to the radar sensor 23 and the vehicle speed sensor 25. The radar ECU 38 acquires a reflection-point sequence input value Ci regarding a sequence of reflection points of an obstacle, such as another vehicle, present around the vehicle from the radar sensor 23, and acquires a vehicle speed input value Ei regarding the speed of the vehicle from the vehicle speed sensor 25. The radar ECU 38 acquires the input time of the reflection-point sequence input value Ci and the input time of the vehicle speed input value Ei on the basis of time information acquired from the system timer. The radar ECU 38 saves the reflection-point sequence input value Ci, the vehicle speed input value Ei and the input times.

In addition, the radar ECU 38 estimates a future reflection-point sequence input value Ci on the basis of the saved current and previous data of the reflection-point sequence input value Ci, and estimates a future vehicle speed input value Ei on the basis of the saved current and previous data of the vehicle speed input value Ei.

The radar ECU 38 generates time-series data of the reflection-point sequence input value Ci, containing the future reflection-point sequence input value Ci (corresponding to the input time-series data N₃ in the second embodiment), and generates time-series data of the vehicle speed input value Ei, containing the future vehicle speed input value Ei (corresponding to the input time-series data N₅ in the second embodiment). The radar ECU 38 generates time-series data regarding a sequence of reflection points through a predetermined process on the basis of the generated time-series data of the reflection-point sequence input value Ci and the generated time-series data of the vehicle speed input value Ei. The radar ECU 38 outputs the generated time-series data regarding a sequence of reflection points to the recognition ECU 42.

The location calculation ECU 39 is electrically connected to the yaw/G sensor 21, the vehicle speed sensor 25 and the GPS detecting unit 26. The location calculation ECU 39 acquires a yaw/G input value Ai regarding the yawing and acceleration of the vehicle from the yaw/G sensor 21. In addition, the location calculation ECU 39 acquires a vehicle speed input value Ei regarding the speed of the vehicle from the vehicle speed sensor 25, and acquires a location input value Fi regarding the location of the vehicle from the GPS detecting unit 26. In addition, the location calculation ECU 39 acquires the input time of the yaw/G input value Ai, the input time of the vehicle speed input value Ei and the input time of the location input value Fi on the basis of time information acquired from the system timer.

The location calculation ECU 39 saves the yaw/G input value Ai, the vehicle speed input value Ei, the location input value Fi and the input times corresponding to the respective input values. The location calculation ECU 39 estimates a future yaw/G input value Ai, a vehicle speed input value Ei and a location input value Fi on the basis of the saved current and previous data of the yaw/G input value Ai, vehicle speed input value Ei and location input value Fi.

The location calculation ECU 39 generates time-series data of the yaw/G input value Ai, containing the future yaw/G input value Ai (corresponding to the input time-series data N₁ in the second embodiment). In addition, the location calculation ECU 39 generates time-series data of the vehicle speed input value Ei, containing the future vehicle speed input value Ei, and generates time-series data of the location input value Fi, containing the future location input value Fi (corresponding to the input time-series data N₆ in the second embodiment).

The location calculation ECU 39 generates time-series data regarding the location of the vehicle and the direction (bearing) of the vehicle through a predetermined process on the basis of the generated pieces of time-series data of the yaw/G input value Ai, vehicle speed input value Ei and location input value Fi. The location calculation ECU 39 outputs the generated time-series data regarding the location of the vehicle and the direction of the vehicle to the recognition ECU 42, the driving target ECU 43 and the driving control ECU 52.

The recognition ECU 42 recognizes the relationship between the vehicle an obstacle around the vehicle on the basis of the pieces of time-series data input from the image ECU 37, the radar ECU 38, the location calculation ECU 39 and the vehicle speed sensor 25. Specifically, the recognition ECU 42 acquires time-series data of the image input value Bi from the image ECU 37. In addition, the recognition ECU 42 acquires time-series data regarding a sequence of reflection points from the radar ECU 38, and acquires time-series data regarding the location and direction of the vehicle from the location calculation ECU 39. Furthermore, the recognition ECU 42 acquires an up-to-date vehicle speed input value Ei from the vehicle speed sensor 25.

The recognition ECU 42 recognizes the type of an obstacle (a pedestrian, another vehicle, a building, or the like), the shape and size of the obstacle, the location of the obstacle, the relative speed between the obstacle and the vehicle and the moving direction of the obstacle through a predetermined process on the basis of the acquired various time-series data and the vehicle speed input value Ei, and then generates piece of time-series data of them. The recognition ECU 42 outputs the generated pieces of time-series data regarding obstacle recognition to the driving target ECU 43.

The driving target ECU 43 calculates a driving target of the vehicle, such as a trajectory, on the basis of data input from the recognition ECU 42, the location calculation ECU 39 and the vehicle speed sensor 25. Specifically, the driving target ECU 43 acquires time-series data regarding obstacle recognition from the recognition ECU 42. In addition, the driving target ECU 43 acquires time-series data regarding the location and direction of the vehicle from the location calculation ECU 39, and acquires an up-to-date vehicle speed input value Ei from the vehicle speed sensor 25.

The driving target ECU 43 generates respective pieces of time-series data of a target trajectory, a target bearing, a target speed, a target time in driving control over the vehicle and reliability of driving control (corresponding to the intermediate computation value time-series data in the second embodiment) through a predetermined process on the basis of the acquired various pieces of time-series data and vehicle speed input value Ei. The driving target ECU 43 outputs time-series data regarding the generated driving target to the driving control ECU 52.

The driving control ECU 52 calculates control variables for controlled objects (engine, brake, steering) of the vehicle on the basis of data input from the driving target ECU 43, the location calculation ECU 39 and the vehicle speed sensor 25. Specifically, the driving control ECU 52 acquires time-series data regarding the driving target from the driving target ECU 43. In addition, the driving target ECU 43 acquires up-to-date time-series data regarding the location and direction of the vehicle from the location calculation ECU 39, and acquires an up-to-date vehicle speed input value Ei from the vehicle speed sensor 25.

The driving control ECU 52 respectively selects selectable data ranges from among the acquired various pieces of time-series data in accordance with the predetermined second selection condition. The driving control ECU 52 calculates an engine output value of the vehicle, which is a control variable to the engine of the vehicle, through a predetermined process on the basis of the data within the selected selectable data ranges and the vehicle speed input value Ei. Similarly, the driving control ECU 52 calculates the hydraulic pressure value of the brake, which is a control variable to the brake, and the target steering angle, which is a control variable to the steering.

The driving control ECU 52 outputs the calculated engine output value as a control target to the engine ECU 61. In addition, the driving control ECU 52 outputs the calculated hydraulic pressure value of the brake as a control target to the brake ECU 62, and outputs the calculated target steering angle as a control target to the steering ECU 63.

The engine ECU 61 computes a fuel injection rate output to the throttle actuator 8 on the basis of the engine output value output from the driving control ECU 52. The engine ECU 61 controls the throttle actuator 8 in accordance with the computed fuel injection rate to thereby control the engine output of the vehicle.

The brake ECU 62 computes the hydraulic pressure value output to the brake actuator 9 of each wheel on the basis of the hydraulic pressure value of the brake output from the driving control ECU 52. The brake ECU 62 controls the brake actuator 9 of each wheel in accordance with the computed hydraulic pressure value to thereby decelerate the vehicle.

The steering ECU 63 computes a motor angle output to the steering actuator 7 on the basis of the target steering angle output from the driving control ECU 52. The steering ECU 63 controls the steering actuator 7 in accordance with the computed motor angle to thereby control the direction of the vehicle.

Next, the operation of the ECUs of the thus configured control target processing system 14 will be described with reference to the accompanying drawings.

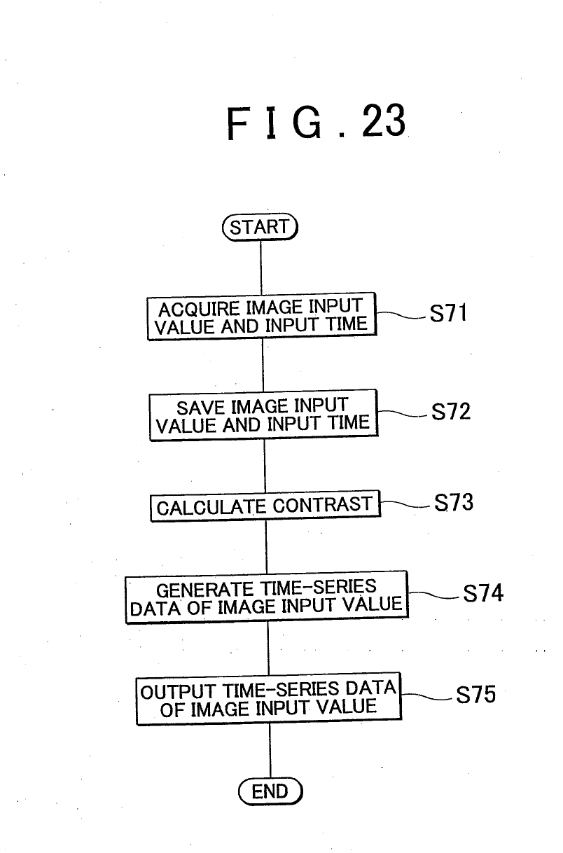

As shown in FIG. 23, the image ECU 37 acquires an image input value Bi regarding an image around the vehicle from the image sensor 22, and acquires an input time of the image input value Bi on the basis of time information acquired from the system timer (S71). The image ECU 37 saves the image input value Bi and the corresponding input time (S72).

Subsequently, the image ECU 37 calculates the contrast of the image of the acquired image input value Bi (S73). The image ECU 37 generates time-series data of the image input value Bi of which the contrast is calculated, and then outputs the time-series data of the image input value Bi to the recognition ECU 42 (S74). After that, the process ends.

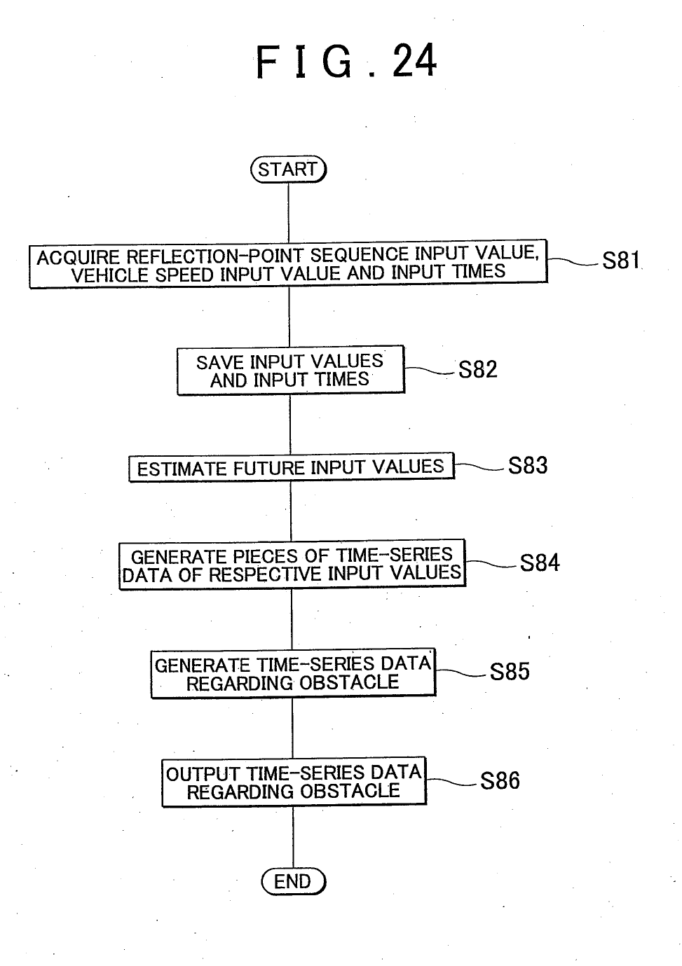

As shown in FIG. 24, the radar ECU 38 acquires a reflection-point line input value Ci and a vehicle speed input value Ei from the radar sensor 23 and the vehicle speed sensor 25, and acquires the input time of the reflection-point line input value Ci and the input time of the vehicle speed input value Ei on the basis of time information acquired from the system timer (S81).

Next, the radar ECU 38 saves, the reflection-point sequence input value Ci, the vehicle speed input value Ei and the input times (S82). The radar ECU 38 estimates a future reflection-point sequence input value Ci on the basis of the saved current and previous data of the reflection-point sequence input value Ci, and estimates a future vehicle speed input value Ei on the basis of the saved current and previous data of the vehicle speed input value Ei (S83).

Subsequently, the radar ECU 38 generates time-series data of the reflection-point sequence input value Ci, containing the future input value, and time-series data of the vehicle speed input value Ei, containing the future input value (S84). The radar ECU 38 generates time-series data regarding a sequence of reflection points on the basis of the generated time-series data of the reflection-point sequence input value Ci and the generated time-series data of the vehicle speed input value Ei (S85). The radar ECU 38 outputs the generated time-series data regarding a sequence of reflection points to the recognition ECU 42 (S86). After that, the process ends.

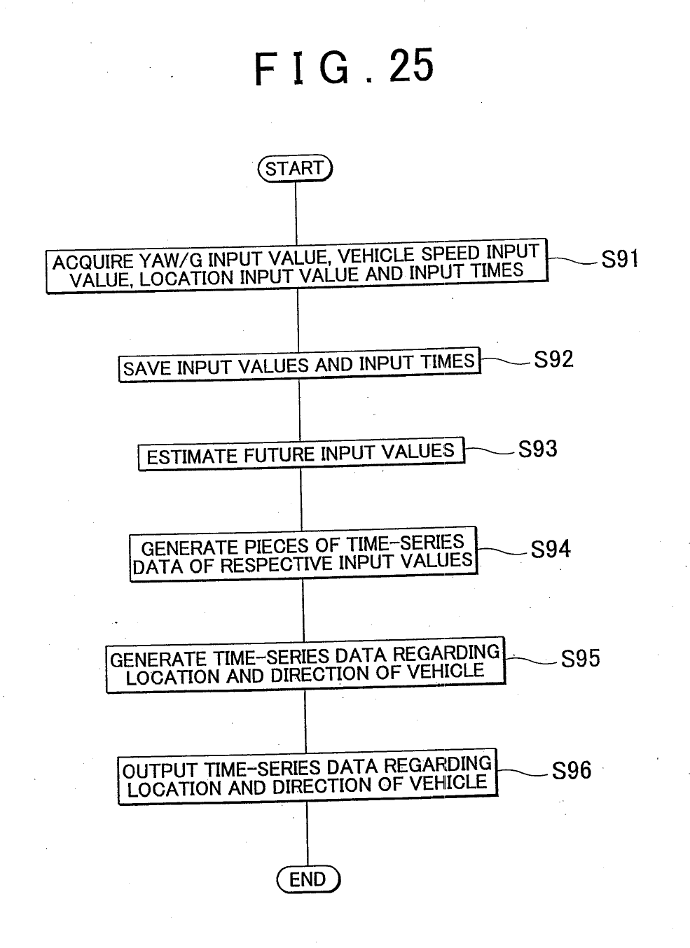

As shown in FIG. 25, the location calculation ECU 39 acquires a yaw/G input value Ai, a vehicle speed input value Ei and a location input value Fi from the yaw/G sensor 21, the vehicle speed sensor 25 and the GPS detecting unit 26, and acquires the input time of the yaw/G input value Ai, the input time of the vehicle speed input value Ei and the input time of the location input value Fi on the basis of time information acquired from the system timer (S91).

The location calculation ECU 39 saves the yaw/G input value Ai, the vehicle speed input value Ei, the location input value Fi and the input times corresponding to the respective input values (S92). After that, the location calculation ECU 39 respectively estimates a future yaw/G input value Ai, a future vehicle speed input value Ei and a future location input value Fi on the basis of the saved current and previous data of the yaw/G input value Ai, the vehicle speed input value Ei and the location input value Fi (S93).

Subsequently, the location calculation ECU 39 generates time series data of the yaw/G input value Ai, containing the future yaw/G input value Ai, time-series data of the vehicle speed input value Ei, containing the future vehicle speed input value Ei, and time-series data of the location input value Fi, containing the future location input value Fi (S94).

The location calculation ECU 39 generates time-series data regarding the location of the vehicle and the direction of the vehicle on the basis of the generated pieces of time-series data of the yaw/G input value Ai, the vehicle speed input value Ei and the location input value Fi (S95). The location calculation ECU 39 outputs the generated time-series data regarding the location and direction of the vehicle to the recognition ECU 42, the driving target ECU 43 and the driving control ECU 52 (S96). After that, the process ends.

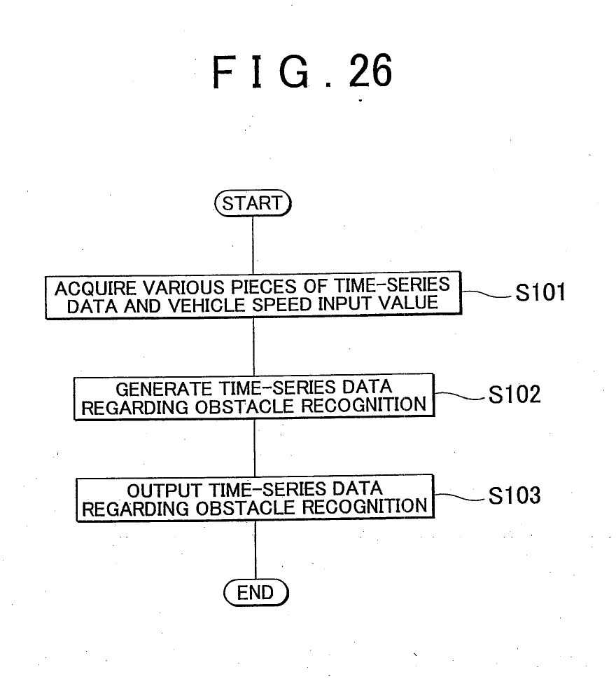

As shown in FIG. 26, the recognition ECU 42 acquires time-series data of an image input value Bi, time-series data regarding an obstacle, time-series data regarding the location and direction of the vehicle and an up-to-date vehicle speed input value Ei from the image ECU 37, the radar ECU 38, the location calculation ECU 39 and the vehicle speed sensor 25 (S101).

The recognition ECU 42 recognizes the type of the obstacle, the shape and size of the obstacle, the location of the obstacle, the relative speed between the obstacle and the vehicle and the moving direction of the obstacle on the basis of the acquired various pieces of time-series data and vehicle speed input value Ei, and then generates pieces of time-series data of them (S102). The recognition ECU 42 outputs the generated pieces of time-series data regarding obstacle recognition to the driving target ECU 43 (S103). After that, the process ends.

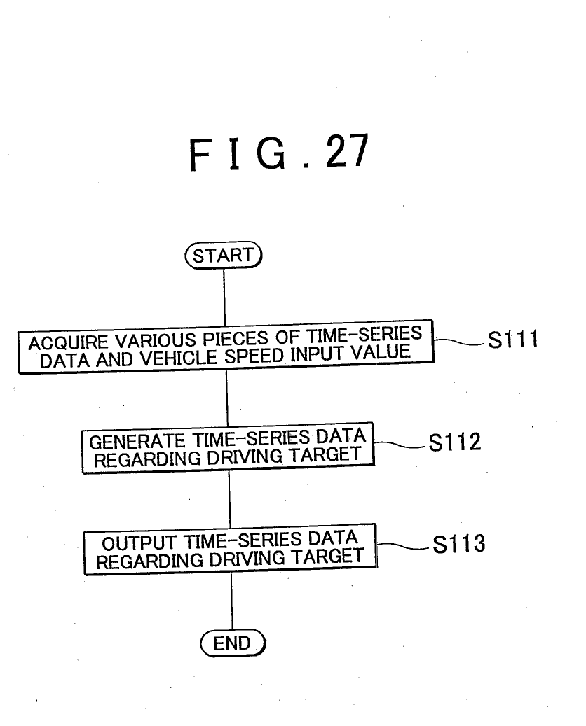

As shown in FIG. 27, the driving target ECU 43 acquires the time-series data regarding obstacle recognition, the time-series data regarding the location and direction of the vehicle and the up-to-date vehicle speed input value Ei from the recognition ECU 42, the location calculation ECU 39 and the vehicle speed sensor 25 (S111).

The driving target ECU 43 generates respective pieces of time-series data of a target trajectory, a target bearing, a target speed, a target time in driving control over the vehicle and reliability of driving control on the basis of the acquired various pieces of time-series data and vehicle speed input value Ei (S112). The driving target ECU 43 outputs the generated pieces of time-series data regarding the driving target to the driving control ECU 52 (S113). After that, the process ends.

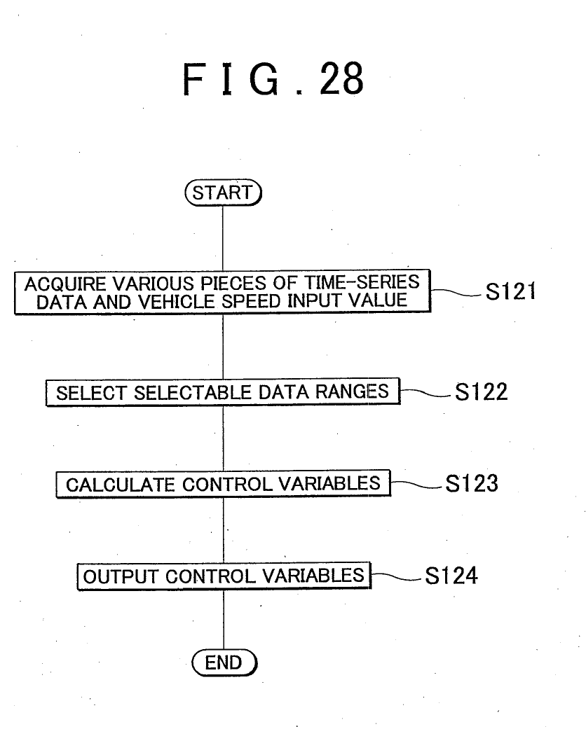

As shown in FIG. 28, the driving control ECU 52 acquires the time-series data regarding the driving target, the time-series data regarding the location and direction of the vehicle and an up-to-date vehicle speed input value Ei from the driving target ECU 43, the location calculation ECU 39 and the vehicle speed sensor 25 (S121).

The driving control ECU 52 respectively selects selectable data ranges from among the acquired various pieces of time-series data in accordance with the predetermined second selection condition (S122). The driving control ECU 52 calculates an engine output value of the vehicle, which is a control variable to the engine of the vehicle, on the basis of the data within the selected selectable data ranges and the vehicle speed input value Ei. Similarly, the driving control ECU 52 calculates the hydraulic pressure value of the brake, which is a control variable to the brake, and the target steering angle, which is a control variable to the steering (S123).

The driving control ECU 52 outputs the calculated control variables as control targets to the engine ECU 61, the brake ECU 62 and the steering ECU 63 (S124). After that, the process ends.

With the above described control target processing system 14, in processes that calculate control variables (an engine output value, a hydraulic pressure value of the brake, a target steering angle) for driving control over the vehicle from various input values, even when irregular processing delay times occur in a plurality of processes, selectable data ranges suitable for calculating control variables may be flexibly selected in accordance with an actual time consumed for processes as described in the second embodiment, so it is possible to improve the reliability of driving control over the vehicle.

In addition, with the control target processing system 14, as described in the fourth embodiment, by directly inputting an up-to-date location input value Ei to the control ECU 51 that executes final process, the influence of temporal deviations in input and output due to a processing period of time may be reduced for the vehicle speed input value Ei, so it is possible to output control variables according to an up-to-date situation. By so doing, feedback control based on a current situation is possible, so it is possible to reduce the influence of an overshoot phenomenon, or the like.

In addition, in the control target processing system 14 as well, as in the case of the third embodiment, the length of time-series data input to the subsequent ECU may be set depending on a processing delay time. In this case, it is possible to reduce the length of data while ensuring the length of the data necessary for the process in the subsequent ECU. Thus, it is possible to reduce the processing load and increase the processing speed.

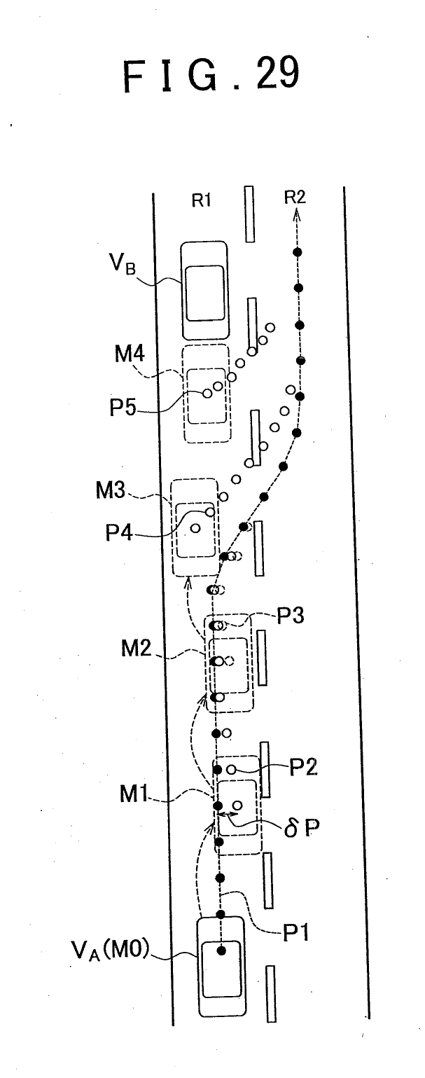

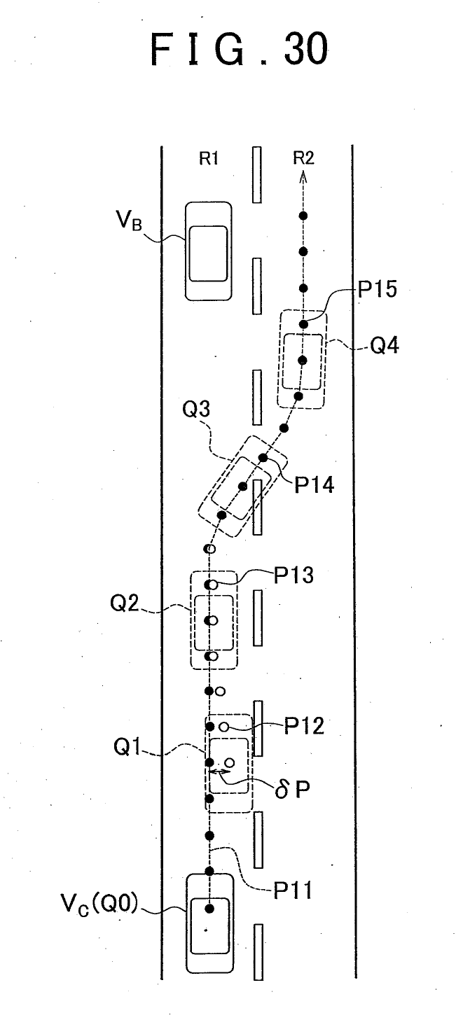

Next, the result of driving control over the vehicle in the case where the control target processing system 14 is used will be described with reference to FIG. 29 and FIG. 30. FIG. 29 is a view that shows the result of driving control over the vehicle that includes no control target processing system 14.

The vehicle V_{A} shown in FIG. 29 includes no control target processing system 14. The vehicle V_{A} has a driving control function for driving control over the vehicle in accordance with a road situation. Because the vehicle V_{A} includes no control target processing system 14, there occurs a delay in control due to a processing delay time of a process in driving control, so there tends to occur a deviation between a target trajectory of driving control and a result of driving control.

Specifically, as shown in FIG. 29, it is assumed that the vehicle V_{A} located at an initial location M0 makes a lane change from a left-side lane R1 to a right-side lane R2 in order to avoid a parked vehicle V_{B} on its trajectory ahead. In the vehicle V_{A}, at the initial location M0, a road situation, such as a current location of the vehicle V_{A} and a distance from the vehicle V_{B}, is recognized from input values input from the various sensors, and a target trajectory P1 for lane change is calculated on the basis of the recognized result.

At this time, between a start of calculation of the target trajectory P1 and an end of the calculation, the location of the vehicle V_{A} in travelling varies from the location M0 because of a temporal difference due to a processing time, a processing delay time, and the like, consumed for calculation of the target trajectory P1. The vehicle V_{A} is located at a location M1 at an end of calculation of the target trajectory P1. The location M1 is deviated by δP in a vehicle transverse direction from the target trajectory P1 because of experienced disturbance, such as strong wind, between a start of calculation of the target trajectory P1 and an end of the calculation. As a result, in the vehicle V_{A}, driving control for the target trajectory P1 calculated to carry out driving control from the initial location M0 starts from the location M1 deviated from the target trajectory P1.

In addition, in the vehicle V_{A}, as the location of the vehicle is recognized to be M1 through information input from the various sensors, a new target trajectory P2 for making a lane change from the location M1 is calculated on the basis of the recognized result. At this time, as in the case where the target trajectory P1 is calculated, the vehicle V_{A} moves from the location M1 to the location M2 until the end of calculation of the target trajectory P2. The location M2 is deviated from the target trajectory P2 because of influence of driving control along the target trajectory at the preceding location M1. As a result, in the vehicle V_{A}, driving control for the target trajectory P2 calculated to carry out driving control from the location M1 starts from the location M2 deviated from the target trajectory P2.

Similarly, driving control for a target trajectory P3 calculated to carry out driving control from the location M2 starts from the location M3, and driving control for a target trajectory P4 calculated to carry out driving control from the location M3 starts from the location M4. In this way, in the vehicle V_{A} with no control target processing system 14, as in the case of the existing art, a variation in road situation due to a temporal deviation between a start of calculation of a target trajectory and an end of the calculation is not considered, so there is a possibility that a delay in control accumulates because of disturbance as a trigger and a large deviation occurs between the target trajectory P1 in driving control and the result of driving control (vehicle locations M2 to M4 in FIG. 29).

FIG. 30 is a view that shows the result of driving control over a vehicle that includes the control target processing system 14. The vehicle V_{C} shown in FIG. 30 has a driving control function of executing driving control over the vehicle in accordance with a road situation and includes the control target processing system 14 according to the present embodiment. In the vehicle V_{C}, appropriate control variables, from which the influence of processing delay times are excluded by the control target processing system 14, may be output to the actuators for controlling the vehicle, so it is possible to implement driving control having high control accuracy and high reliability.

Specifically, as shown in FIG. 30, it is assumed that the vehicle V_{C} located at an initial location Q0 makes a lane change from a left-side lane R1 to a right-side lane R2 in order to avoid a parked vehicle V_{B} on its trajectory ahead. At this time, in the vehicle V_{C}, a road situation, such as a current location of the vehicle V_{C} and a distance from the vehicle V_{B}, is recognized by the recognition ECU 42 as time-series data including a future road situation on the basis of input values input from the various sensors 21 to 23, 25 and 26. Then, a driving target based on the recognized result of the recognition ECU 42 is calculated as time-series data (intermediate computation value time-series data) by the driving target ECU 43, and a target trajectory P11, which is a driving control target, for the lane change is calculated by the driving control ECU 52 as time-series data.

At this time, between a start of calculation of the target trajectory P11 and an end of the calculation, there is a temporal difference, due to a processing time, a processing delay time, and the like, for calculating the target trajectory P11, so the location of the vehicle V_{C} in travelling varies from the initial location Q0. The vehicle V_{C} is located at a location Q1 at the time of an end of calculation of the target trajectory P11. The location Q1 is deviated by SP in a vehicle transverse direction from the target trajectory P11 because of experienced disturbance, such as strong wind, between a start of calculation of the target trajectory P11 and an end of the calculation.

In the vehicle V_{C}, the target trajectory P11 is calculated as time-series data, so it is possible, to select control variables used for driving control from among the time-series data of the target trajectory P11 so as to reduce the influence of a variation in road situation (variation in location of the vehicle V_{C}) due to a temporal difference between the start of calculation of the target trajectory P11 and the end of the calculation. Thus, even when driving control starts from the location Q1 deviated from the target trajectory P11 because of disturbance, driving control having higher accuracy than that of the above described vehicle V_{A} is executed.

In addition, in the vehicle V_{C}, as the location of the vehicle V_{C} is recognized to be Q1 through information input from the various sensors 21, 25 and 26, a new target trajectory P12 for making a lane change from the location Q1 is calculated on the basis of the recognized result. At this time, as in the case where the target trajectory P11 is calculated, the vehicle V_{C} moves from the location Q1 to the location Q2 on the target trajectory P12 until the end of calculation of the target trajectory P12. In the vehicle V_{G} driving control along the target trajectory P12 appropriately starts from the location Q2 on the target trajectory P12.

Similarly, driving control along a target trajectory P13 that is started to be calculated at the location Q2 starts from a location Q3, and driving control along a target trajectory P14 that is started to be calculated at the location Q3 starts from a location Q4. In this way, in the vehicle V_{C} that includes the control target processing system 14, driving control in consideration of a variation in road situation due to a temporal difference between a start of calculation of a target trajectory and an end of the calculation is carried out, so the influence of disturbance is adequately reduced. Thus, the reliability of driving control is improved.

### Sixth Embodiment

Next, a control target processing system 15 according to a sixth embodiment will be described with reference to the accompanying drawings. The control target processing system 15 according to the sixth embodiment mainly differs from that of the second embodiment in that a plurality of input values all are input to a data management ECU 44 and are comprehensively managed and in that control variables are calculated on the basis of a control timing at which the vehicle actually undergoes driving control.

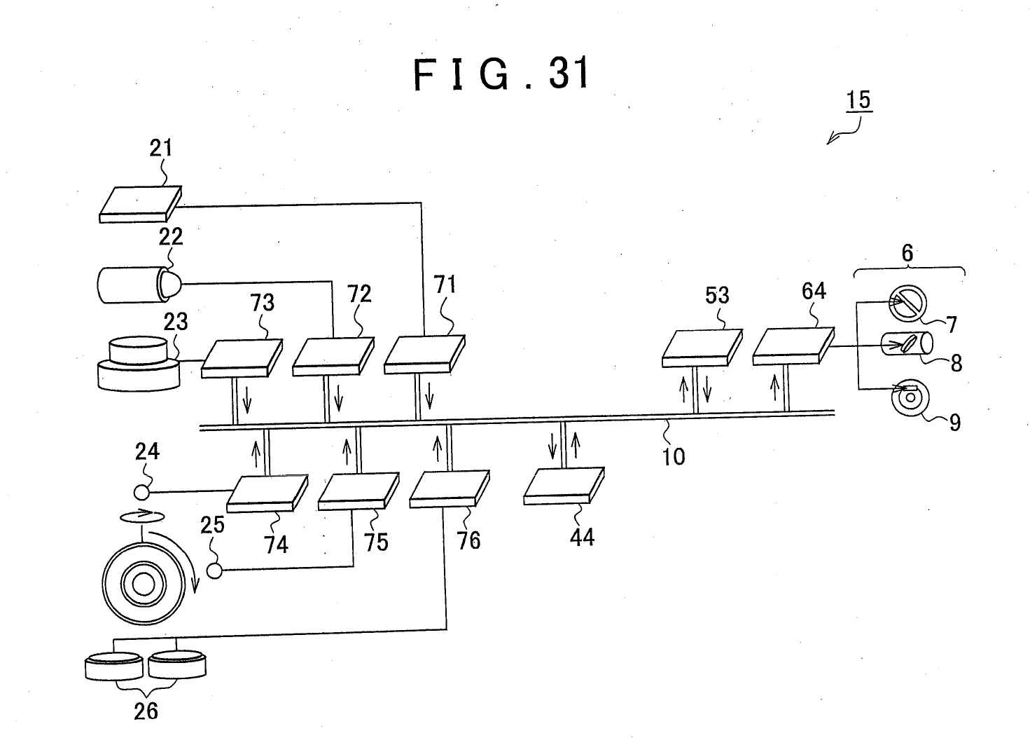

As shown in FIG. 31, the control target processing system 15 includes a yaw/G sensor 21, an image sensor 22, a radar sensor 23, a steering angle sensor 24, a vehicle speed sensor 25 and a GPS detecting unit 26. Furthermore, the control target processing system 15 includes input ECUs 71 to 76, the data management ECU 44, a control ECU 53 and an actuator control ECU 64. In addition, the data management ECU 44, the control ECU 53 and the actuator control ECU 64 are electrically connected to one another through a vehicle LAN 10, and share a system timer for acquiring time information. Note that the input ECUs 71 to 76 function as a first generating unit, the data management ECU 44 functions as a second generating unit, and the control ECU 53 functions as a selecting unit and an output unit.

The input ECUs 71 to 76 respectively acquire various input values Ai to Fi from the various sensors 21 to 26. In addition, the input ECUs 71 to 76 respectively acquire input times of the various input values Ai to Fi on the basis of time information acquired from the system timer. The input ECUs 71 to 76 respectively save the various input values Ai to Fi and the input times corresponding to the various input values Ai to Fi. The input ECUs 71 to 76 respectively output the various input values Ai to Fi and the corresponding input times to the data management ECU 44.

The data management ECU 44 manages the various input values Ai to Fi input from the input ECUs 71 to 76 and the input times corresponding to the respective various input values Ai to Fi. The data management ECU 44 acquires the various input values Ai to Fi and the input times corresponding to the various input values Ai to Fi from the input ECUs 71 to 76. The data management ECU 44 saves the various input values Ai to Fi and the input times corresponding to the various input values Ai to Fi.

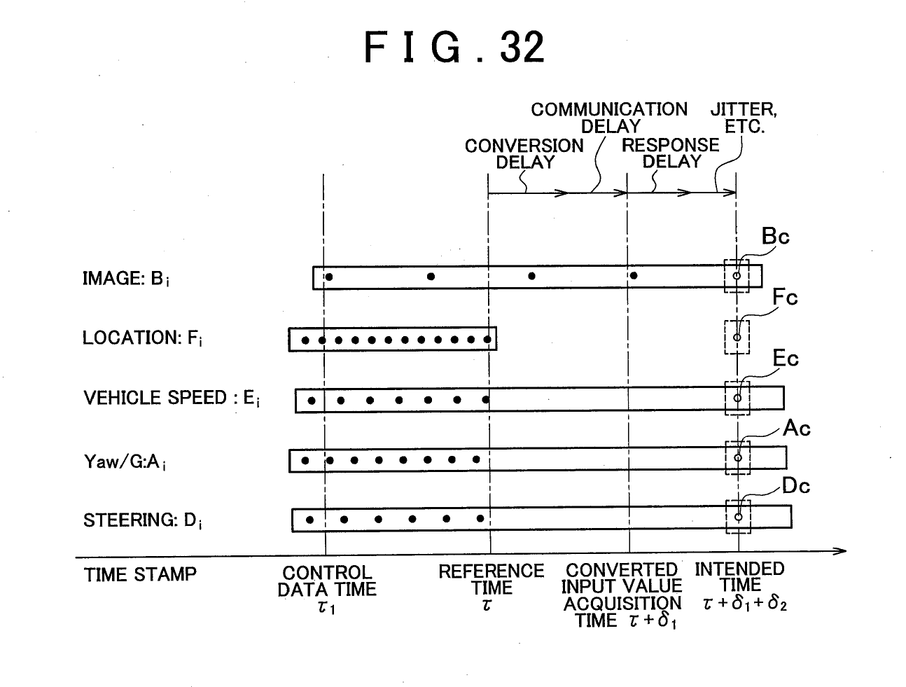

In addition, as the data management ECU 44 receives a data request signal from the control ECU 53, which will be described later, the data management ECU 44 recognizes the type of data and an intended time (control timing), required from the control ECU 53, on the basis of the data request signal (see FIG. 32). The data management ECU 44 acquires the input values of the required types (for example, various input values Ai, Bi, Di to Fi, other than the obstacle input value Ci, shown in FIG. 32) from among the saved various input values Ai to Fi. Then, the data management ECU 44 converts the input values of the acquired types into values (Ac, Bc, Dc, Ec and Fc) at the intended time through a predetermined conversion process. The data management ECU 44 outputs the converted input values, converted into the values at the intended time, to the control ECU 53.

The control ECU 53 calculates control variables on the basis of the acquired various pieces of data, and outputs the control variables to the actuator control ECU 64 that controls the actuators 6. The control ECU 53 acquires time information from the system timer. In addition, the control ECU 53 and the actuator control ECU 64 are synchronized with each other by a shared operation clock. The control ECU 53 recognizes an input timing, at which the control variables output from the control ECU 53 are input to the actuator control ECU 64, through an operation clock. Similarly, the control ECU 53 recognizes the timing at which the actuators 6 are driven by the actuator control ECU 64 (timing of D/A conversion in the actuator control ECU 64, which will be described later) through an operation clock.

In addition, the control ECU 53 directly receives a location input value Fi from the input ECU 76. The control ECU 53 calculates a delay in response from the driving timing of the actuators 6 to the timing at which the vehicle actually undergoes driving control on the basis of the driving timing of the actuators 6 and a variation in location input value Fi (a variation in location of the vehicle).

The control ECU 53 calculates a control timing, at which the vehicle actually undergoes driving control in accordance with the control variables output from the control ECU 53, on the basis of the above described time information, input timing, driving timing and delay in response. The control ECU 53 outputs a data request signal for acquiring input values necessary for calculating control variables used at this control timing to the data management ECU 44.

The control ECU 53 acquires the converted input values, converted so as to correspond to the control timing, from the data management ECU 44. The control ECU 53 calculates control variables on the basis of the acquired converted input values. The control ECU 53 outputs the calculated control variables to the actuator control ECU 64.

At this time, when the control ECU 53 can output control variables earlier than a control variable output timing calculated back from the calculated control timing (timing at which the control ECU 53 outputs control variables to the actuator control ECU 64), the control ECU 53 outputs control variables after waiting until the control variable output timing. As a result, it is possible to prevent a situation that a deviation occurs between the calculated control timing and a timing at which the vehicle actually undergoes driving control because the control variables are output earlier than the control variable output timing, so it is possible to improve the accuracy of control over the vehicle.

The actuator control ECU 64 controls the operation of the actuators 6 for controlling the vehicle on the basis of the control variables input from the control ECU 53. The actuator control ECU 64 acquires the control variables from the control ECU 53. The actuator control ECU 64 performs a digital-to-analog conversion (D/A conversion) on the acquired control variables. The actuator control ECU 64 performs a voltage-current conversion (V-I conversion) on the D/A converted control variables. The actuator control ECU 64 supplies the V-I converted control variables to solenoids and motors to thereby control the operation of the actuators 6 in accordance with the control variables.

Next, the operation of the ECUs of the control target processing system 15 will be described with reference to the accompanying drawings.

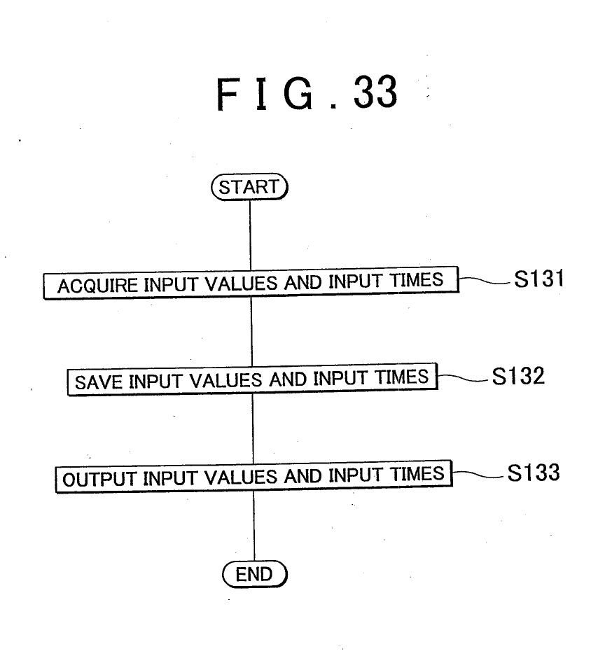

As shown in FIG. 33, the input ECUs 71 to 76 respectively acquire various input values Ai to Fi from the various sensors 21 to 26, and acquire respective input times of the various input values Ai to Fi on the basis of time information acquired from the system timer (S131). The input ECUs 71 to 76 respectively save the acquired various input values Ai to Fi and the input times corresponding to the various input values Ai to Fi (S132). The input ECUs 71 to 76 output the various input values Ai to Fi and the input times to the data management ECU 44 (S133). After that, the process ends.

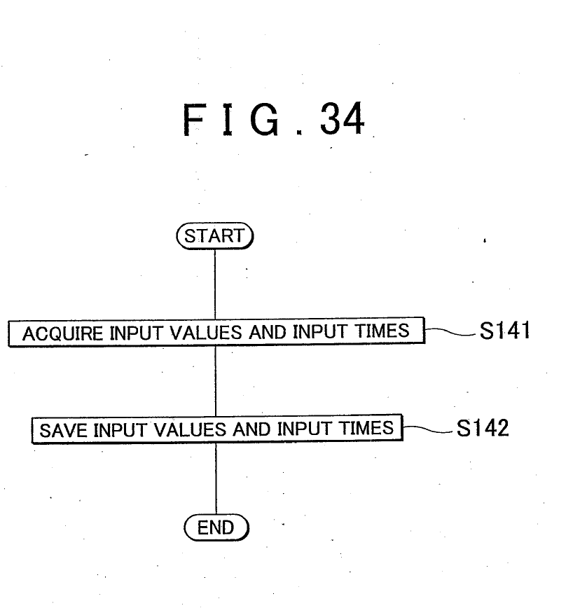

As shown in FIG. 34, the data management ECU 44 acquires the various input values Ai to Fi and the input times corresponding to the various input values Ai to Fi from the input ECUs 71 to 76 (S141). The data management ECU 44 saves the various input values Ai to Fi and the input times corresponding to the various input values Ai to Fi (S142). After that, the process ends.

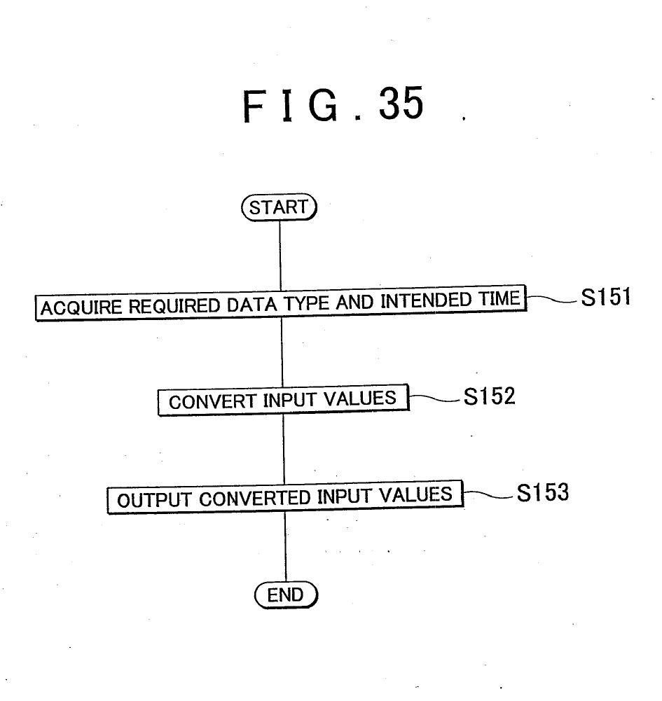

As shown in FIG. 32 and FIG. 35, when a data request signal is input from the control ECU 53, the data management ECU 44 recognizes the type of data required from the control ECU 53 and an intended time on the basis of the data request signal (S151). The intended time is expressed by τ+δ1+δ2 where a current time is τ, a delay time consumed for conversion process in the data management ECU 44 and communication between the data management ECU 44 and the control ECU 53 is δ1 and a delay in response from the driving timing of the actuators 6 to the timing at which the vehicle actually undergoes driving control, jitter, or the like, is δ2.

The data management ECU 44 acquires the input values of the required types from among the saved various input values Ai to Fi. The data management ECU 44 converts the input values of the acquired types into values at the intended time through a predetermined conversion process (S152). The data management ECU 44 outputs the converted input values, converted into the values at the intended time, to the control ECU 53 (S153). At this time, a time at which the control ECU 53 acquires the converted input values output from the data management ECU 44 is expressed by τ+δ1. After that, the data management ECU 44 ends the process.

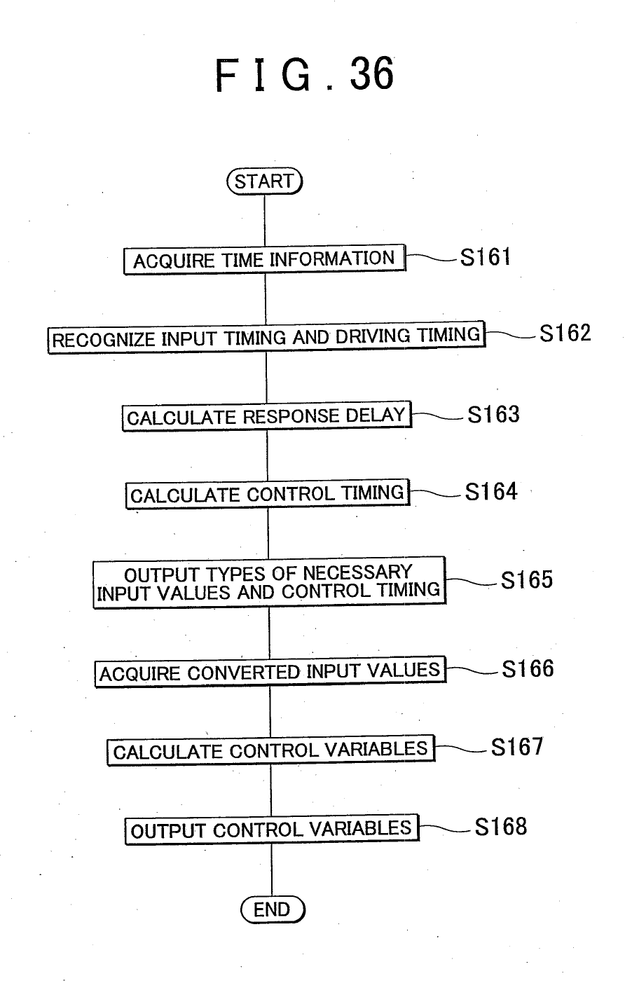

As shown in FIG. 36, the control ECU 53 acquires time information from the system timer (S161). Subsequently, the control ECU 53 recognizes an input timing, at which the control variables output from the control ECU 53 are input to the actuator control ECU 64, and a driving timing, at which the actuators 6 are driven by the actuator control ECU 64, through an operation clock (S162). Furthermore, the control ECU 53 calculates a delay in response from the driving timing of the actuators 6 to the timing at which the vehicle actually undergoes driving control on the basis of a variation in location input value Fi from the input ECU 76 and the driving timing of the actuators 6 (S163).

The control ECU 53 calculates the control tinting at which the vehicle actually undergoes driving control on the basis of the above described time information, input timing, driving timing and delay in response (S164). The control ECU 53 outputs the types of input values necessary for calculating control variables corresponding to the control timing and the control timing (intended time) as a data request signal to the data management ECU 44 in order to calculate the control variables (S165).

The control ECU 53 acquires the converted input values input from the data management ECU 44 (S166). The control ECU 53 calculates control variables on the basis of the acquired converted input values (S167). The control ECU 53 outputs the calculated control variables to the actuator control ECU 64 (S168). After that, the process ends.

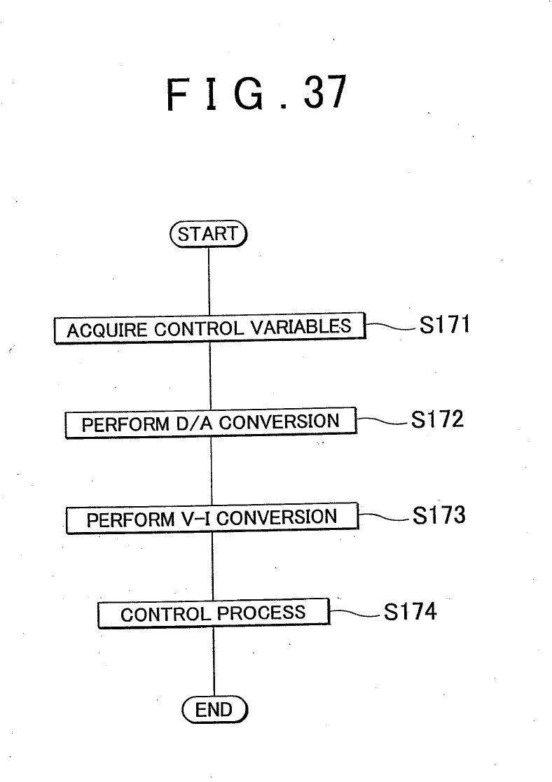

As shown in FIG. 37, the actuator control ECU 64 acquires the control variables from the control ECU 53 (S171). The actuator control ECU 64 performs D/A conversion on the acquired control variables (S172). The actuator control ECU 64 performs V-I conversion on the D/A converted control variables (S173). The actuator control ECU 64 controls the operation of the actuators 6 in accordance with the V-I converted control variables (S174). After that, the process ends.

With the above described control target processing system 15, control variables are calculated on the basis of values converted into the input values at a control timing at which the vehicle actually undergoes driving control, so the influence of processing delay times in calculation of control variables may be excluded, and it is possible to output control targets having high accuracy. Specifically, a time τ+δ1+δ2 is obtained by adding a delay time δ1 due to conversion process of the data management ECU 44 and a period of time for communication between the ECUs and a delay time δ2 due to a delay in response, jitter, or the like, from the driving timing of the actuators 6 to the timing at which the vehicle actually undergoes driving control to a current time τ, and the time τ+δ1+δ2 is used as an intended time (control timing). By so doing, control using the input values at the actual control timing is executed, and it is possible to improve control accuracy.

In addition, by calculating the control timing in this way, it is possible to not only output control targets on the basis of the control timing but also adjust the calculated control targets in consideration of a delay in communication with the actuators 6. Furthermore, such control targets are not limited to the ones calculated on the basis of the input time-series data; instead, an engine output value (control target) may be directly calculated from a vehicle speed input value Ei input from the vehicle speed sensor 25 and then output.

### Seventh Embodiment

Next, a control target processing system 16 according to a seventh embodiment will be described with reference to the accompanying drawings. The control target processing system 16 according to the seventh embodiment mainly differs from that of the second embodiment in that control variables are calculated on the basis of an assumed most delay time (worst value) of processing times consumed for calculating the control variables.

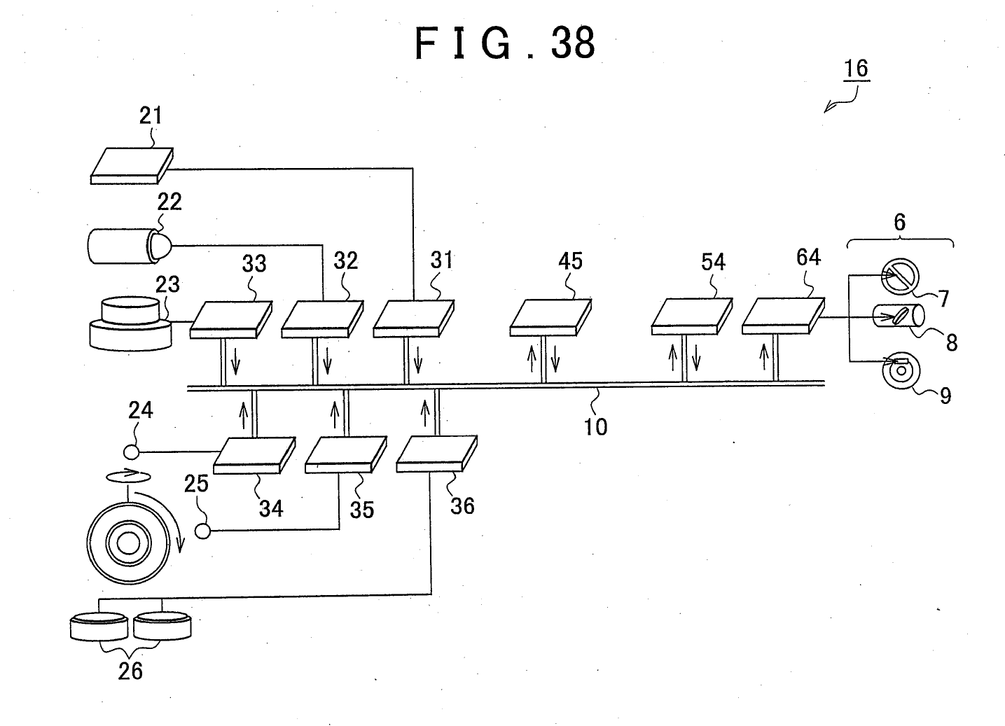

As shown in FIG. 38, the control target processing system 16 according to the present embodiment includes a yaw/G sensor 21, an image sensor 22, a radar sensor 23, a steering angle sensor 24, a vehicle speed sensor 25 and a GPS detecting unit 26. Furthermore, the control target processing system 16 includes input ECUs 31 to 36, a recognition ECU 45, a control ECU 54 and an actuator control ECU 64. In addition, the input ECUs 31 to 36, the recognition ECU 45, the control ECU 54 and the actuator control ECU 64 are electrically connected to one another through a vehicle LAN 10, and share a system timer for acquiring time information. Here, the input ECUs 31 to 36 function as a first generating unit, the recognition ECU 45 functions as a second generating unit, and the control ECU 54 functions as a selecting unit and an output unit. Note that the input ECUs 31 to 36 and the actuator control ECU 64 are the same as the input ECUs and the actuator control ECU according to the above described second and sixth embodiments, so the description thereof is omitted.

The recognition ECU 45 recognizes a road situation around the vehicle (for example, presence or absence of an obstacle, a location of the obstacle) on the basis of pieces of input time-series data N₁ to N₆ input from the input ECUs 31 to 36. Specifically, the recognition ECU 45 acquires the pieces of input time-series data N₁ to N₆ from the respective input ECUs 31 to 36, and acquires time information from the system timer. The recognition ECU 45 recognizes a road situation around the vehicle on the basis of the pieces of input time-series data N₁ to N₆.

The recognition ECU 45 saves the recognized result of the road situation and a time corresponding to the recognized result (for example, a time at which the road situation is recognized from the input value data). The recognition ECU 45 estimates a recognized result of a future road situation on the basis of the saved current and previous recognized results. The recognition ECU 45 generates time-series data of the road situation, containing the estimated future recognized result, on the basis of the estimated future recognized result and the saved current and previous recognized results. The recognition ECU 45 outputs the generated time-series data of the recognized result and the pieces of input time-series data N₁ to N₆ to the control ECU 54.

The control ECU 54 calculates control variables on the basis of the acquired various data, and then outputs the calculated control variables to the actuator control ECU 64. The control ECU 54 acquires the time-series data of the recognized results and the pieces of input time-series data N₁ to N₆ from the recognition ECU 45. In addition, the control ECU 54 acquires time information from the system timer.

The control ECU 54 and the actuator control ECU 64 are synchronized with each other by a shared operation clock. The control ECU 54 recognizes an input timing, at which the control variables output from the control ECU 54 are input to the actuator control ECU 64, through an operation clock. Similarly, the control ECU 54 recognizes the tinting, at which the actuators 6 are driven by the actuator control ECU 64, through an operation clock.

In addition, the control ECU 54 directly receives a location input value Fi from the input ECU 36. The control ECU 54 calculates a delay in response from the driving timing of the actuators 6 to the timing at which the vehicle actually undergoes driving control on the basis of the driving timing of the actuators 6 and a variation in location input value Fi. The control ECU 54 calculates a control timing, at which the vehicle actually undergoes driving control in accordance with the control variables output from the control ECU 54, on the basis of the above described time information, input timing, driving timing and delay in response. The control timing is calculated in consideration of a case where an assumed largest delay occurs in control variable calculation process of the control ECU 54.

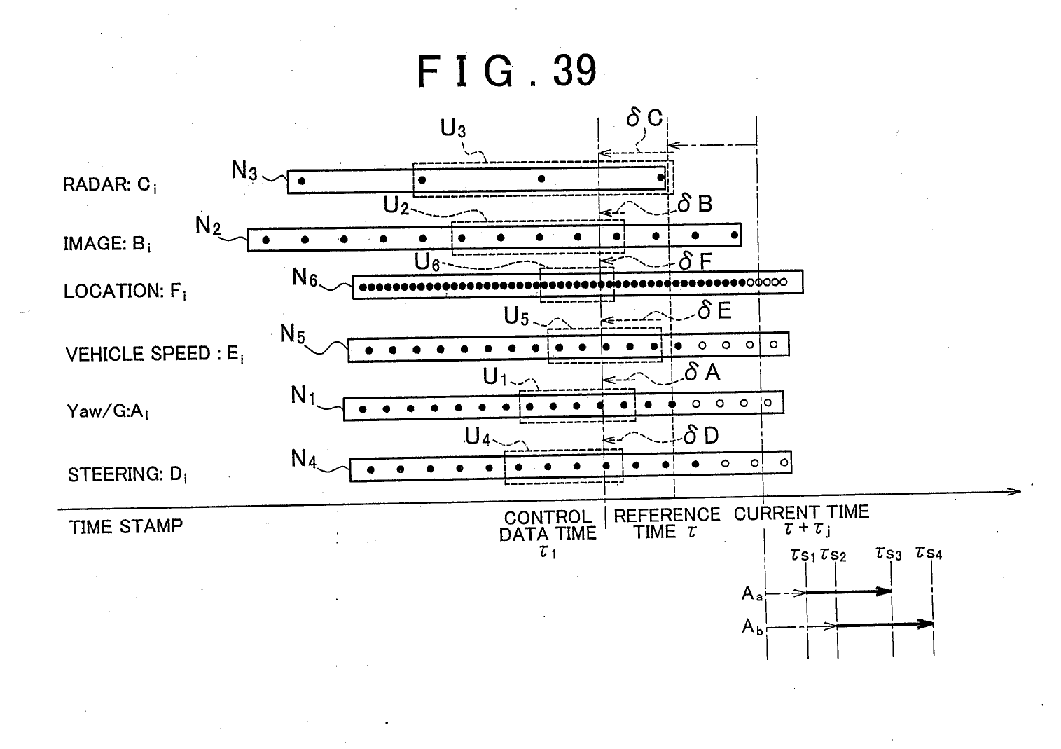

Here, the arrow Aₐ in FIG. 39 indicates the progress of the process when the control variable calculation process in the control ECU 54 ends without delay. As indicated by the arrow Aₐ, when the control variable calculation process ends without delay, as control variables calculated at an end timing τ_{S1} of the control variable calculation process are output from the control ECU 54 to the actuator control ECU 64, a control timing at which the vehicle actually undergoes driving control is τ_{S3}. On the other hand, the arrow A_{b} in FIG. 39 indicates the progress of the process when an assumed largest delay occurs in the control variable calculation process. As indicated by the arrow A_{b}, when a delay occurs in the control variable calculation process, the end timing τ_{S2} of the control variable calculation process is later than τ_{S1}. As the control variables are output from the control ECU 54 to the actuator control ECU 64 at the end timing τ_{S2}, the control timing is a timing τ_{S4} that is later than τ_{S3}. The control ECU 54 calculates the control timing τ_{S4} in a case where an assumed largest delay occurs on the basis of the above described time information, input timing, driving timing and delay in response.

The control ECU 54 respectively selects selectable data ranges U₁ to U₆ from among the pieces of input time-series data N₁ to N₆ in accordance with the predetermined second selection condition so as to calculate optimal control variables at the calculated control timing τ_{S4}. Specifically, as shown in FIG. 39, the control ECU 54 selects data ranges at control data time τ1 before a reference time τ, which is a reference of data selection, as selectable data ranges U₁ to U₆ in consideration of sensor delays (period of times consumed until an actual situation is detected as an input value) SA to SF in the various sensors 21 to 26. The number of input values contained in each of the selectable data ranges U₁ to U₆ and temporal ranges with respect to the control data time τ1 are, for example, appropriately selected for the mathematical expressions used in the subsequent process.

The control ECU 54 calculates control variables on the basis of the input value data in the selected selectable data ranges U₁ to U₆ and the time-series data of the recognized result of the road situation. The control ECU 54 outputs the calculated control variables to the actuator control ECU 64. At this time, even when there is no delay or a slight delay in the control variable calculation process as indicated by the arrow Aₐ in FIG. 39, the control ECU 54 waits output until the timing at which the control variables are output coincides with τ_{S2}. As a result, it is possible to prevent a situation that a deviation occurs between the calculated control timing τ_{S4} and a timing at which the vehicle actually undergoes driving control because the control variables are output earlier than τ_{S2}, so it is possible to improve the accuracy of control over the vehicle.

Next, the operation of the recognition ECU 45 and the operation of the control ECU 54 in the control target processing system 15 will be described with reference to the accompanying drawings.

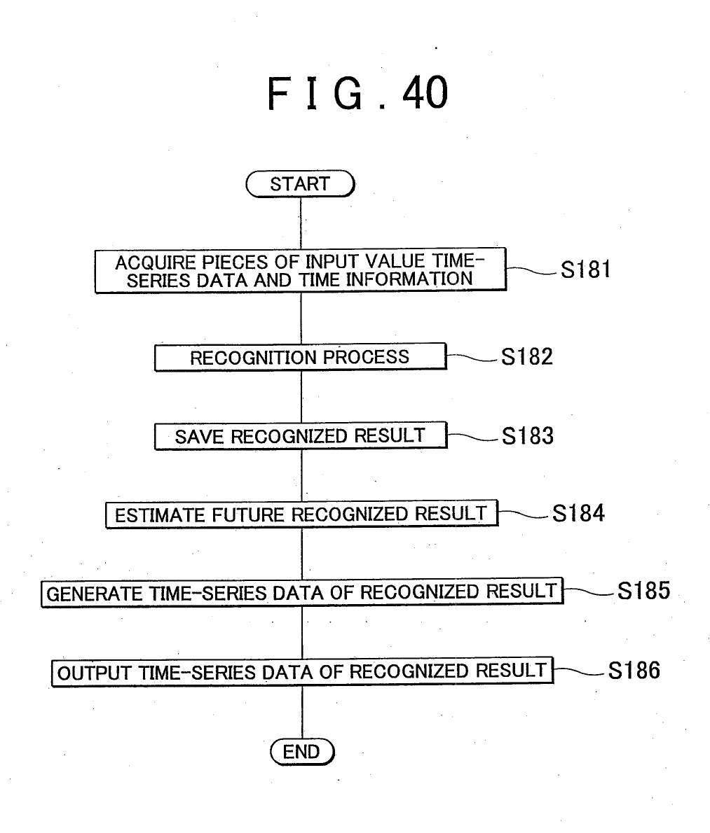

As shown in FIG. 40, the recognition ECU 45 acquires the pieces of input time-series data N₁ to N₆ from the respective input ECUs 31 to 36, and acquires time information from the system timer (S181). The recognition ECU 45 recognizes a road situation around the vehicle on the basis of the pieces of input time-series data N₁ to N₆ (S182).

Subsequently, the recognition ECU 45 saves the recognized result of the road situation and the time corresponding to the recognized result (S183). The recognition ECU 45 estimates a recognized result of a future road situation on the basis of the saved current and previous recognized results (S184). The recognition ECU 45 generates time-series data of the road situation, containing the estimated future recognized result, on the basis of the estimated future recognized result and the saved current and previous recognized results (S185). The recognition ECU 45 outputs the generated time-series data of the recognized result and the pieces of input time-series data N₁ to N₆ to the control ECU 54 (S186). After that, the process ends.

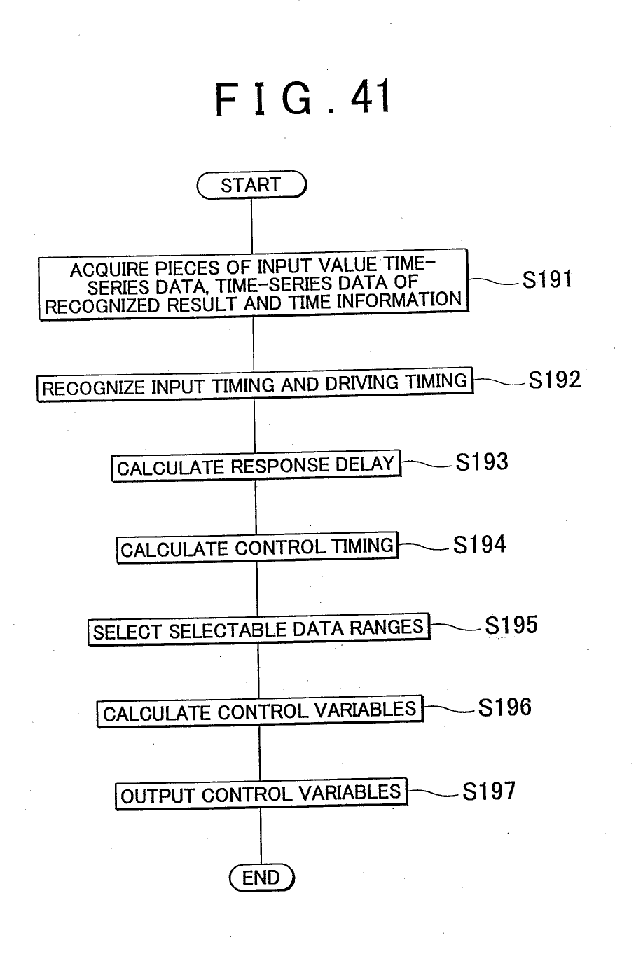

As shown in FIG. 41, the control ECU 54 acquires the generated time-series data of the recognized result and pieces of input time-series data N₁ to N₆ from the recognition ECU 45, and acquires time information from the system timer (S191). Subsequently, the control ECU 54 recognizes an input timing, at which the control variables output from the control ECU 54 are input to the actuator control ECU 64, through an operation clock and recognizes a timing at which the actuators 6 are driven by the actuator control ECU 64 through an operation clock (S192). After that, the control ECU 54 calculates a delay in response from the driving timing of the actuators 6 to the timing at which the vehicle actually undergoes driving control on the basis of the driving timing of the actuators 6 and a variation in location input value Fi (S193).

After that, the control ECU 54 calculates a control timing τ_{S4} in a case where an assumed largest delay occurs on the basis of the above described time information, input timing, driving timing and delay in response (S194). The control ECU 54 respectively selects selectable data ranges U₁ to U₆ from among the pieces of input time-series data N₁ to N₆ in accordance with the predetermined second selection condition so as to calculate optimal control variables at the calculated control timing τ_{S4} (S195).

The control ECU 54 calculates control variables on the basis of the input value data in the selected selectable data ranges U₁ to U₆ and the time-series data of the recognized result of the road situation (S196). The control ECU 54 outputs the calculated control, variables to the actuator control ECU 64 (S197). After that, the process ends.

With the above described control target processing system 16, selectable data ranges U₁ to U₆ are selected so as to calculate optimal control variables that receive small influence of processing delay times at the control timing τ_{S4} at which the vehicle actually undergoes driving control, so the influence of processing delay times in calculation of control variables may be excluded, and it is possible to execute driving control having high control accuracy.

Specifically, as shown in FIG. 30, it is assumed that the vehicle V_{C} located at an initial location Q0 makes a lane change from a left-side lane R1 to a right-side lane R2 in order to avoid a parked vehicle V_{B} on the trajectory. In the vehicle V_{C} that includes the control target processing system 16, a control timing τ_{S4} that is most delayed among the timings at which the vehicle actually undergoes driving control in the control ECU 54 is calculated. Then, selectable data ranges U₁ to U₆ are respectively selected from among the pieces of input time-series data N₁ to N₆ in accordance with the predetermined second selection condition so as to calculate optimal control variables at the calculated control timing τ_{S4}.

The control ECU 54 calculates control variables (one of target points that constitute the target trajectory P11) at the control timing τ_{S4} on the basis of the input value data in these selectable data ranges U₁ to U₆. The control ECU 54 outputs the calculated control variables to the actuator control ECU 64. At this time, even when there is no delay or a slight delay in the control variable calculation process, the control ECU 54 waits output until the timing at which the control variables are output coincides with τ_{S2} to thereby adjust the control timing to τ_{S4}.

In this way, in the vehicle that includes the control target processing system 16, even when there is no delay or a slight delay in control process in the control ECU 54, output is waited so that the timing at which the control variables are output coincides with τ_{S2} to thereby make it possible to suppress a deviation between the calculated control timing τ_{S4} and the timing at which the vehicle actually undergoes driving control, so it is possible to improve the accuracy of control over the vehicle. Furthermore, the control ECU 54 calculates control variables on the basis of selectable data ranges U₁ to U₆ selected in accordance with the predetermined second selection condition so as to calculate optimal control variables at the control timing τ_{S4}. By so doing, the influence of processing delay times in calculation of control variables may be excluded, and it is possible to execute driving control having-high control accuracy. As a result, even when the location of the vehicle V_{C} is deviated from the target trajectory P11 to the location Q1 by δP in the vehicle transverse direction because of disturbance, such as strong wind, the influence due to disturbance is highly likely to be corrected by high-accuracy driving control to cause the vehicle V_{C} to return onto the target trajectory P11. By so doing, the reliability of driving control is improved.

The embodiments of the invention are described above; however, the aspect of the invention is not limited to the above described embodiments. For example, the controlled object is not limited to a vehicle; instead, the controlled object may be various mobile units, such as an aircraft and a robot.

In addition, the features of the first to seventh embodiments may be appropriately combined depending on a controlled object or the details of control.

1. A control target processing system comprising:
a first generating unit that generates first time-series data that are time-series data of an input value;
a second generating unit that is formed of a plurality of processing units, that exchanges time-series data among the plurality of processing units, and that calculates intermediate computation values corresponding to the respective input values contained in the first time-series data through predetermined processes in the respective processing units to thereby generate second time-series data that are time-series data of the intermediate computation value;
a selecting unit that selects a selection value from among the second time-series data in accordance with a first selection condition; and
an output unit that calculates a control variable for controlling a controlled object on the basis of the selection value and then outputs the control variable as a control target.

2. The control target processing system according to claim 1, wherein
the first generating unit estimates a future input value and generates the first time-series data containing the future input value.

3. The control target processing system according to claim 1, wherein
the first generating unit generates a plurality of pieces of first time-series data that temporally partially overlap, and
the second generating unit generates a plurality of pieces of second time-series data corresponding to the respective pieces of first time-series data.

4. The control target processing system according to claim 1, wherein
the first selection condition is set on the basis of a time at which the selection value is selected.

5. The control target processing system according to claim 1, wherein
the first generating unit generates a plurality of types of first time-series data corresponding to a plurality of types of input value,
the second generating unit generates a plurality of types of second time-series data on the basis of the plurality of types of first time-series data,
the selecting unit selects selectable data ranges from among the respective types of second time-series data in accordance with a second selection condition, and
the output unit calculates the control variable from intermediate computation values contained in the respective selectable data ranges.

6. The control target processing system according to claim 5, wherein
an input value of a predetermined type is input to the output unit, and
the output unit calculates the control variable on the basis of intermediate computation values contained in the respective selectable data ranges and the input value of the predetermined type.

7. The control target processing system according to claim 5, wherein
the second selection condition is set on the basis of a processing period of time of the respective types of second time-series data.

8. The control target processing system according to claim 1, wherein
the first generating unit generates the first time-series data having a time length set on the basis of a processing period of time.

9. The control target processing system according to claim 8, wherein
in the second generating unit, each of the processing units outputs the time-series data, having a time length set on the basis of a processing period of time of a subsequent one of the processing units, to the subsequent one of the processing units.

10. The control target processing system according to claim 9, wherein
the second generating unit outputs the second time-series data, having a time length set on the basis of a processing period of time of the output unit, to the output unit.

11. The control target processing system according to claim 8, wherein
the processing period of time includes a processing delay time.

12. The control target processing system according to claim 1, further comprising:
a calculation unit that calculates a control timing at which the controlled object is controlled in accordance with the control variable, wherein
the output unit outputs the control target on the basis of the control timing.

13. The control target processing system according to claim 1, wherein
the input value is a value detected by a sensor equipped for a vehicle, the intermediate computation value is a value regarding a driving target of the vehicle, and
the control variable is a control variable for at least any one of an engine, a brake and a steering.
